(19) United States
(12) Patent Application Publication
(10) Pub. No.: US 2009/0142622 A1
(43) Pub. Date: Jun. 4, 2009

(54) MAGNETIC RECORDING MEDIUM

(75) Inventor: Kenichi NAKAMURA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/327,105

(22) Filed: Dec. 3, 2008

(30) Foreign Application Priority Data
Dec. 3, 2007 (JP) 2007-311864

(51) Int. Cl. G11B 5/70

(52) U.S. Cl. 428/831; 428/840.6; 428/840

(57) ABSTRACT

The present invention provides a magnetic recording medium comprising an undercoating layer comprising a radiation-curable compound that has been cured by irradiation with radiation, a nonmagnetic layer comprising a nonmagnetic powder and a binder, and a magnetic layer comprising a ferromagnetic powder and a binder in this order on a nonmagnetic support, wherein the magnetic layer and/or the nonmagnetic layer comprise a carbonic ester denoted by general formula (1), and the undercoating layer has an indentation hardness lower than that of the nonmagnetic support.

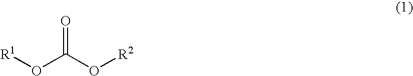

In general formula (1), each of R¹ and R² independently denotes a saturated hydrocarbon group, with a total number of carbon atoms in R¹ and R² being equal to or higher than 12 but equal to or lower than 50.

### CROSS-REFERENCE TO RELATED APPLICATIONS

This application claims the benefit of priority under 35 USC 119 to Japanese Patent Application No. 2007-311864 filed on Dec. 3, 2007, which is expressly incorporated herein by reference in its entirety.

### BACKGROUND OF THE INVENTION

1. Field of the Invention

The present invention relates to a magnetic recording medium having good magnetic characteristics, and more particularly, to a magnetic recording medium permitting high-density recording, exhibiting good electromagnetic characteristics, and achieving good running durability in drive systems under a variety of environmental conditions.

2. Discussion of the Background

In recent years, the digitizing of magnetic recording media has progressed with the aim of preventing the deterioration of recorded signals due to repeated copying. In this process, the quantity of data recorded has increased. There is thus a need for media with increased recording density. Increasing the recording density requires reducing the thickness loss and self-demagnetization loss of a medium, so thinning of the magnetic layer has been examined. However, when the magnetic layer is thinned, the surface properties of the nonmagnetic support may affect the surface properties of the magnetic layer, sometimes compromising electromagnetic characteristics.

In recent years, the technique of providing a nonmagnetic layer on the surface of the support and providing the magnetic layer over this nonmagnetic layer has been employed to prevent such negative effects caused by the surface properties of the nonmagnetic support. Such technique is disclosed in, for example, Japanese Unexamined Patent Publication (KOKAI) Showa No. 63-191315 or English language family member U.S. Pat. No. 4,963,433 and Japanese Unexamined Patent Publication (KOKAI) Showa No. 63-191318. The contents of these applications are expressly incorporated herein by reference in their entirety.

Methods of further improving surface properties by providing an undercoating layer (smoothing layer) between the nonmagnetic support and the nonmagnetic layer have been proposed. For example, Japanese Unexamined Patent Publication (KOKAI) No. 2003-281710 or English language family member US2003/0180578 A1 and Japanese Unexamined Patent Publication (KOKAI) No. 2004-334988, which are expressly incorporated herein by reference in their entirety, disclose the providing of an undercoating layer formed of radiation-curable resin and the manufacturing of a magnetic recording medium with an extremely smooth magnetic layer surface.

Additionally, information must be stably inputted and outputted through the drive system in a magnetic recording medium. Thus, normally, lubricants such as hydrocarbons, fatty acids, and fatty esters are added to the magnetic layer and/or nonmagnetic layer to improve running durability and stabilize information input and output. For example, Japanese Unexamined Patent Publication (KOKAI) Heisei No. 7-138586, Japanese Unexamined Patent Publication (KOKAI) Heisei No. 8-77547 or English language family member U.S. Pat. No. 5,560,983, and Japanese Unexamined Patent Publication (KOKAI) No. 2003-323711 or English language family member US 2003/0211362 A1 disclose various lubricants for enhancing running durability. The contents of these applications are expressly incorporated herein by reference in their entirety.

For example, magnetic recording media having undercoating layers formed of radiation-curable resin, such as those described in above-cited Japanese Unexamined Patent Publication (KOKAI) No. 2003-281710 and Japanese Unexamined Patent Publication (KOKAI) No. 2004-334988, afford magnetic layers with surfaces that are extremely smooth. However, the smoother the surface of the magnetic layer, the greater the frictional resistance upon contact with the drive system (for example, a magnetic head or the like). Thus, running failures (such as increased friction and adhesion (known as “sticking”) between the magnetic head and the magnetic recording medium,) and related information input/output errors tend to occur. This effect is particularly pronounced in environments of high and low humidity.

### SUMMARY OF THE INVENTION

An aspect of the present invention provides for a magnetic recording medium that permits good recording and reproduction in a variety of environments, more particularly, for a magnetic recording medium permitting extremely high-density recording, exhibiting good electromagnetic characteristics, and achieving running durability in drive systems under a variety of environmental conditions.

To achieve the above-stated magnetic recording medium, the present inventor conducted extensive research into the reasons for the occurrence of input/output errors, and made the following discoveries.

Running failures tend to occur in a magnetic recording medium in which an undercoating layer is provided to achieve a magnetic layer with a smooth surface, as set forth above. Generally, a lubricant is added to the magnetic layer and/or nonmagnetic layer to reduce running failures. However, the lubricants described in Japanese Unexamined Patent Publication (KOKAI) Heisei No. 7-138586, Japanese Unexamined Patent Publication (KOKAI) Heisei No. 8-77547 and Japanese Unexamined Patent Publication (KOKAI) No. 2003-323711 are inadequate for improving the running durability under a variety of environmental conditions in magnetic recording media with extremely smooth magnetic layer surfaces, for example. In particular, in highly humid environments (particularly environments of both high temperature and high humidity), friction increases between the magnetic head and the magnetic recording medium and information input/output errors tend to occur. As a result of extensive research, the present inventor determined that this increase in friction tends to occur due to adhesion to the magnetic head of grime such as fatty acid metal salts resulting from the hydrolysis of lubricants (such as fatty acids and fatty esters) contained in the magnetic recording medium. Further, he found that the increase in friction causes shaving of the surface of the magnetic layer, thereby diminishing the magnetic head cleaning effect through the loss of friction by protrusions formed by abrasives, further promoting the occurrence of input/output errors.

It was also determined that in an environment of low humidity (particularly an environment of low temperature and low humidity), the magnetic head cleaning effects by abrasives is lower than in an environment of ordinary humidity or high humidity. Thus, grime that adheres to the magnetic head cannot be adequately removed and input/output errors tend to occur.

The present inventor conducted further extensive research based on the above discoveries, resulting in the discovery that the above-stated magnetic recording medium could be achieved by employing a carbonic ester with good resistance to hydrolysis as a lubricant and by rendering an undercoating layer containing a radiation-curable compound that had been cured by irradiation with radiation more flexible than the nonmagnetic support. The present invention was devised on that basis.

The present invention relates to a magnetic recording medium comprising an undercoating layer comprising a radiation-curable compound that has been cured by irradiation with radiation, a nonmagnetic layer comprising a nonmagnetic powder and a binder, and a magnetic layer comprising a ferromagnetic powder and a binder in this order on a nonmagnetic support, wherein

the magnetic layer and/or the nonmagnetic layer comprise a carbonic ester denoted by general formula (1), and

the undercoating layer has an indentation hardness lower than that of the nonmagnetic support.

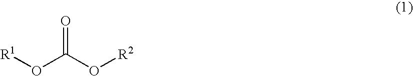

In general formula (1), each of R¹ and R² independently denotes a saturated hydrocarbon group, with a total number of carbon atoms in R¹ and R² being equal to or higher than 12 but equal to or lower than 50.

In general formula (1), at least one of R¹ and R² may denote a saturated hydrocarbon group having a branched structure.

The branched structure may be present at a β position in the saturated hydrocarbon group.

In general formula (1), one of R¹ and R² may denote 2-methylpropyl group, 2-methylbutyl group or 2-ethylhexyl group.

Among R¹ and R² in general formula (1), one may denote a saturated hydrocarbon group having a branched structure and the other may denote a saturated hydrocarbon group having a linear structure.

The saturated hydrocarbon group having a linear structure may have 12 to 20 carbon atoms.

The nonmagnetic layer may have a thickness ranging from 0.1 to 2.0 μm.

The magnetic layer may have a surface resistivity ranging from 1×10⁴ to 1×10⁸ Ω/□.

The above magnetic recording medium may comprise an electrically conductive polymer compound in at least one of the undercoating layer, the nonmagnetic layer, and the magnetic layer.

The electrically conductive polymer compound may be polyaniline and/or a derivative thereof.

The present invention can provide a magnetic recording medium permitting extremely high-density recording, exhibiting good electromagnetic characteristics, and achieving good running durability under a variety of environmental conditions.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 is a drawing of the shape of an indenter employed in measuring indentation hardness (DH).

FIG. 2 is a drawing describing how indentation hardness (DH) is defined.

FIG. 3 is a drawing showing a cross-section of a magnetic recording medium relating to an implementation embodiment of the present invention.

FIG. 4 is a drawing describing the method of measuring the surface resistivity of the magnetic layer.

FIG. 5 is a schematic of an example of a magnetic recording medium production line.

Explanations of symbols in the drawings are as follows:
1: Magnetic recording medium; 10: Nonmagnetic support; 12: Undercoating layer; 14: Nonmagnetic layer; 16: Magnetic layer; 18: Backcoat layer; 22: Tape surface; 24: Rear surface of tape; 30: Roll of nonmagnetic support stock material; 32: Undercoating layer coating element; 34: Undercoating layer drying and curing element; 36: Nonmagnetic layer coating element; 38: Nonmagnetic layer drying element; 40: Magnetic layer coating element; 42: Magnetic layer drying element; 44: Roll of magnetic recording medium stock material.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

The present invention relates to a magnetic recording medium comprising an undercoating layer comprising a radiation-curable compound that has been cured by irradiation with radiation, a nonmagnetic layer comprising a nonmagnetic powder and a binder, and a magnetic layer comprising a ferromagnetic powder and a binder in this order on a nonmagnetic support. In the magnetic recording medium of the present invention, the magnetic layer and/or the nonmagnetic layer comprise a carbonic ester denoted by general formula (1), and the undercoating layer has an indentation hardness lower than that of the nonmagnetic support.

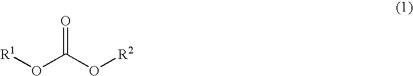

In general formula (1), each of R¹ and R² independently denotes a saturated hydrocarbon group, with a total number of carbon atoms in R¹ and R² being equal to or higher than 12 but equal to or lower than 50.

The magnetic recording medium of the present invention comprises an undercoating layer comprising a radiation-curable compound that has been cured by irradiation with radiation between a nonmagnetic support and a nonmagnetic layer. The radiation-curable compound has the property of curing by polymerization or by crosslinking to form a polymer when irradiated with radiation (for example, energy such as an electron beam or ultraviolet radiation). Since the curing reaction does not take place without exposure to radiation, the coating liquid containing the radiation-curable compound is of relatively low viscosity, and the viscosity is stable in the absence of radiation. Thus, a smooth undercoating layer can be achieved by coating an undercoating layer coating liquid containing the radiation-curable compound to a nonmagnetic support, and masking the coarse protrusions on the surface of the support through a leveling effect until the coating liquid dries.

In the present invention, an undercoating layer of lower indentation hardness than the nonmagnetic support is employed as the undercoating layer. Employing an undercoating layer with a lower indentation hardness than the nonmagnetic support can allow the undercoating layer to suitably absorb the high pressure that is locally exerted by contact between the magnetic head and the magnetic layer while the magnetic recording medium is running in the course of inputting and outputting information. This can reduce scratching of the magnetic layer and damaging of the magnetic head, and permit better contact between the magnetic head and magnetic layer.

Rendering the undercoating layer more flexible than the nonmagnetic support to impart a suitable cushioning effect can yield improved cleaning and running properties. These will be described below.

Protrusions of varying height, formed of abrasive, carbon black, and the like, are present on the surface of the magnetic layer. The abrasives have a cleaning effect on the magnetic head, and carbon black has the effect of improving running properties by matting the surface. Thus, protrusions coming into contact with the magnetic head perform such functions, and protrusions of a height that precludes contact cannot perform such functions.

The higher the protrusion, the greater the pressure exerted by the magnetic head. However, in an undercoating layer of lower indentation hardness than the nonmagnetic support, a cushioning effect is exerted on protrusions that are subjected to high pressure in this manner, having the effect of depressing some of the protrusions. As a result, even protrusions of a height that would preclude contact with the magnetic head in a magnetic recording medium in which the undercoating layer was not provided or the indentation hardness of the undercoating layer was higher than that of the nonmagnetic support also come into contact with the magnetic head, performing the above functions. That is, the numerous protrusions of abrasive, carbon black, and the like that are present on the surface of the magnetic layer come into effective contact with the magnetic head, having the effects of removing grime that has adhered to the magnetic head and improving running properties. Further, imparting a suitable cushioning property by means of the undercoating layer can reduce reduction through wear and tear of protrusions formed by abrasive on the surface of the magnetic layer and diminish wear and tear of the magnetic head. Thus, the cleaning effect of abrasive on the magnetic head can be maintained for an extended period and the service lifetime of the magnetic head can be extended.

Further, in the magnetic recording medium of the present invention, the magnetic layer and/or the nonmagnetic layer comprises a carbonic ester denoted by general formula (1). The above carbonic ester tends not to hydrolyze, yielding a good lubricating effect under a variety of environmental conditions (low temperature/low humidity, low temperature/high humidity, high temperature/low humidity, high temperature/high humidity). The above carbonic ester can reduce information input/output errors caused by head grime due to products (known as “fatty acid metal salts”) created by the bonding of metal ions contained in the magnetic layer, nonmagnetic layer, or the like with fatty acids produced by the hydrolysis of lubricants such as the fatty esters that have been conventionally employed in magnetic recording media. It can also improve storage durability over extended periods.

In this manner, the magnetic recording medium of the present invention permits good recording and reproduction in a variety of environments.

The magnetic recording medium of the present invention will be described in greater detail below.

### Undercoating Layer

The magnetic recording medium of the present invention comprises an undercoating layer between a nonmagnetic support and a nonmagnetic layer. The undercoating layer comprises a radiation-curable compound that has been cured by irradiation with radiation. The radiation-curable compound has the property of polymerizing or crosslinking to form a polymer when exposed to energy in the form of radiation such as an electron beam or ultraviolet radiation. Curing of the radiation-curable compound in the undercoating layer by polymerization or crosslinking can form an undercoating layer of suitable flexibility, yielding the above-described desirable effects.

Forming an undercoating layer of coating liquid containing the radiation-curable compound can yield a highly smooth coating. This is because the radiation-curable compound is of relatively low viscosity, so the masking effect on protrusions and pinholes in the surface of the support due to the leveling effect following the coating of an undercoating layer comprising such a radiation-curable compound is high. Accordingly, providing a nonmagnetic layer and a magnetic layer on an undercoating layer formed by curing a radiation-curable compound can yield a smooth magnetic layer, permitting the manufacturing of a magnetic recording medium affording good electromagnetic characteristics. This effect can be particularly pronounced in relatively thin magnetic layers with a thickness of 0.01 to 1.0 micrometer. Protrusions due to the surface properties of the support can be reduced on the surface of magnetic layers of such thickness, and, in particular, noise can be efficiently reduced in magnetic recording with MR heads.

Examples of the radiation-curable compound are: acrylic esters, acrylamides, methacrylic esters, methacrylic amides, allyl compounds, vinyl ethers, and vinyl esters. Of these, acrylic esters and methacrylic esters are preferred. Acrylic esters having two or more radiation-curable functional groups (acryloyl groups) are particularly preferred.

From the perspective of imparting suitable flexibility to the undercoating layer, it is desirable to suitably adjust the number of acryloyl groups contained in the radiation-curable compound. Acrylic esters having two acryloyl groups are preferred. Volumetric shrinkage caused by crosslinking or polymerization can also be diminished by employing acrylic esters having two acryloyl groups.

Specific examples of radiation-curable compounds having two acryloyl groups are: cyclopropane diacrylate, cyclopentane diacrylate, cyclohexane diacrylate, cyclobutane diacrylate, dimethylol cyclopropane diacrylate, dimethylol cyclopentane diacrylate, dimethylol cyclohexane diacrylate, dimethylol cyclobutane diacrylate, cyclopropane dimethacrylate, cyclopentane dimethacrylate, cyclohexane dimethacrylate, cyclobutane dimethacrylate, dimethylol cyclopropane dimethacrylate, dimethylol cyclopentane dimethacrylate, dimethylol cyclohexane dimethacrylate, dimethylol cyclobutane dimethacrylate, bicyclobutane diacrylate, bicyclooctane diacrylate, bicyclononane diacrylate, bicycloundecane diacrylate, dimethylol bicyclobutane diacrylate, dimethylol bicyclooctane diacrylate, dimethylol bicyclononane diacrylate, bicyclobutane dimethacrylate, bicyclooctane dimethacrylate, bicyclononane dimethacrylate, bicycloundecane dimethacrylate, dimethylol bicyclobutane dimethacrylate, dimethylol bicyclooctane dimethacrylate, dimethylol bicyclononane dimethacrylate, dimethylol bicycloundecane dimethacrylate, tricycloheptane diacrylate, tricyclodecane diacrylate, tricyclododecane diacrylate, tricycloundecane diacrylate, tricyclotetradecane diacrylate, tricyclodecane tridecane diacrylate, dimethylol tricycloheptane diacrylate, dimethylol tricyclodecane diacrylate, dimethylol tricyclododecane diacrylate, dimethylol tricycloundecane diacrylate, dimethylol tricyclotetradecane diacrylate, dimethylol tricyclodecane tridecane diacrylate, tricycloheptane dimethacrylate, tricyclodecane dimethacrylate, tricyclododecane dimethacrylate, tricycloundecane dimethacrylate, tricyclotetradecane dimethacrylate, tricyclodecane tridecane dimethacrylate, dimethylol tricycloheptane dimethacrylate, dimethylol tricyclodecane dimethacrylate, dimethylol tricyclododecane dimethacrylate, dimethylol tricycloundecane dimethacrylate, dimethylol tricyclotetradecane dimethacrylate, dimethylol tricyclodecane tridecane dimethacrylate, spirooctane diacrylate, spiroheptane diacrylate, spirodecane diacrylate, cyclopentane spirocyclobutane diacrylate, cyclohexane spirocyclopentane diacrylate, spirobicyclohexane diacrylate, dispiroheptadecane diacrylate, dimethylol spirooctane diacrylate, dimethylol spiroheptane diacrylate, dimethylol spirodecane diacrylate, dimethylol cyclopentane spirocyclobutane diacrylate, dimethylol cyclohexane spirocyclopentane diacrylate, dimethylol spirobicyclohexane diacrylate, dimethylol dispiroheptadecane diacrylate, spirooctane dimethacrylate, spiroheptane dimethacrylate, spirodecane dimethacrylate, cyclopentane spirocyclobutane dimethacrylate, cyclohexane spirocyclopentane dimethacrylate, spirobicyclohexane dimethacrylate, dispiroheptadecane dimethacrylate, dimethylol spirooctane dimethacrylate, dimethylol spiroheptane dimethacrylate, dimethylol spirodecane dimethacrylate, dimethylol cyclopentane spirocyclobutane dimethacrylate, dimethylol cyclohexane spirocyclopentane dimethacrylate, dimethylol spirobicyclohexane dimethacrylate, and dimethylol dispiroheptadecane dimethacrylate.

A radiation-curable compound having an alicyclic ring structure is desirably employed as the radiation-curable compound. The alicyclic ring structure comprises, for example, a cyclo skeleton, bicyclo skeleton, tricyclo skeleton, spiro skeleton, or dispiro skeleton. Of these, a radiation-curable compound having a structure comprised of multiple rings that share atoms, such as a radiation-curable compound having a bicyclo skeleton, tricyclo skeleton, spiro skeleton, or dispiro skeleton, is desirable. Such radiation-curable compounds have higher glass transition temperatures than aliphatic compounds, so viscosity failures tend not to occur during the steps following coating of the undercoating layer and desirable flexibility can be imparted to the undercoating layer. Further, compounds having a cyclohexane ring, or bicylo, tricyclo, spiro, or similar alicyclic ring structure can undergo little shrinkage during curing, adhere firmly to the support, and afford good running durability.

Among radiation-curable compounds having an alicyclic ring structure, those compounds having two or more radiation-curable functional groups per molecule are desirable. Of these, dimethylol tricyclodecane diacrylate, dimethylol bicyclooctane diacrylate, and dimethylol spirooctane diacrylate are desirable and dimethylol tricyclodecane diacrylate is preferred. Specific examples of commercially available compounds are: KAYARAD R-684 (Nippon Kayaku Co., Ltd.), Lite Acrylate DCP-A (Kyoeisha Chemical Co., Ltd.), and LUMICURE DCA-200 (Dainippon Ink and Chemicals Corporation).

The molecular weight of the radiation-curable compound is desirably 200 to 1,000, preferably 200 to 500. The viscosity of the radiation-curable compound at 25° C. is desirably 5 to 200 mPa·s, preferably 5 to 100 mPa·s.

Multiple radiation-curable compounds can be employed in combination in the undercoating layer.

An undercoating layer coating liquid can be prepared by dissolving the radiation-curable compound in solvent. The viscosity of the undercoating layer coating liquid is desirably 2 to 200 mPa·s. The solvent employed in the undercoating layer coating liquid is desirably methyl ethyl ketone (MEK), cyclohexanone, methanol, ethanol, or toluene.

After coating the undercoating layer coating liquid on a nonmagnetic support and drying it, the radiation-curable compound that is contained can be cured by irradiation with radiation to form the undercoating layer.

Suitable flexibility can be imparted to the undercoating layer by suitably adjusting the cured state of the radiation-curable compound by crosslinking or polymerization. For example, the cured state of the radiation-curable compound can be controlled by adjusting the intensity of the radiation, adjusting the oxygen atmosphere in the course of curing with radiation, and adjusting the quantity of polymerization initiator added.

By way of example, an electron beam or ultraviolet radiation can be employed as the radiation. The use of an electron beam is desirable in that no polymerization initiator is required. When employing ultraviolet radiation, a photopolymerization initiator is added to the undercoating layer coating liquid.

When employing an electron beam, a scanning type, double scanning type, or curtain beam type electron beam accelerator may be employed. The use of a curtain beam type electron beam accelerator that achieves high output relatively inexpensively is desirable. The electron beam acceleration voltage is normally 30 to 1,000 kV, desirably 50 to 300 kV. The absorbed dose is normally 0.5 to 20 Mrad, desirably 2 to 10 Mrad. An electron beam generated at an acceleration voltage of less than 30 kV affords an inadequate energy transmission level. An electron beam generated at an acceleration voltage exceeding 300 kV is uneconomical due to reduced efficiency of the energy employed in polymerization of the radiation-curable compound.

Examples of ultraviolet radiation sources that can be employed are: low-pressure mercury lamps, high-pressure mercury lamps, ultrahigh-pressure mercury lamps, chemical lamps, and metal halide lamps. The use of a high-pressure mercury lamp with good irradiation efficiency is desirable. The photopolymerization initiator employed for UV curing of the radiation-curable compound can be in the form of a photo-induced radical polymerization initiator. For example, the initiators described in “New Experimental Study of Polymers, Vol. 2, Chapter 6, Light and Radiation Polymerization” (published by Kyoritsu Shuppan Co., Ltd., 1995, edited by the Polymer Society), which is expressly incorporated herein by reference in its entirety, can be employed as photo-induced radical polymerization initiators. Specific examples are: acetophenone, benzophenone, anthraquinone, benzoin ethyl ether, benzyl methyl ketal, benzyl ethyl ketal, benzoin isobutyl ketone, hydroxydimethyl phenyl ketone, 1-hydroxycyclohexylphenyl ketone, and 2,2-diethoxyacetophenone. The blending ratio of the photopolymerization initiator is normally 0.5 to 20 weight parts, desirably 2 to 15 weight parts, and preferably, 3 to 10 weight parts, per 100 weight parts of radiation-curable compound.

Known techniques, such as those described in “UV-EB Curing Techniques” (published by Japan Electric Cable Technology Center, Inc.) and “Applied Techniques of Low Energy Electron-Beam Irradiation” (published by CMC in 2000) which are expressly incorporated herein by reference in their entirety, can be consulted for curing by radiation exposure and for the radiation curing device.

An oxygen concentration of equal to or less than 1,000 ppm is desirable in the atmosphere during curing of the radiation-curable compound in the undercoating layer by irradiation with radiation. A high oxygen concentration sometimes impedes the crosslinking reaction or polymerization reaction of the radiation-curable compound contained in the undercoating layer. The oxygen concentration during this process is desirably equal to or less than 500 ppm, preferably equal to or less than 200 ppm, and more preferably, equal to or less than 50 ppm. The method of substituting nitrogen for excess oxygen (nitrogen purging) is desirably employed to achieve an atmospheric oxygen concentration of equal to or less than 1,000 ppm.

The curing reaction of the radiation-curable compound is desirably conducted so as to impart suitable flexibility to the undercoating layer and cure the undercoating layer to a degree at which the undercoating layer is not dissolved by the coating solvent employed to form the nonmagnetic layer and magnetic layer that are provided over the undercoating layer. Further, the radiation-curable compound in the undercoating layer is desirably cured so that there are few components contained in the undercoating layer that will dissolve in the coating solvent employed for the nonmagnetic layer and magnetic layer. When there are numerous components dissolving in the coating solvent employed for the nonmagnetic layer and magnetic layer, the flexibility of the undercoating layer may decrease and the surface properties of the nonmagnetic and magnetic layers sometimes deteriorate. When components of the undercoating layer precipitate onto the surface of the magnetic layer, the magnetic head tends to collect grime, causing errors in the course of information input/output. The radiation-curable compound is desirably cured so that the components dissolving into the nonmagnetic layer and magnetic layer constitute equal to or less than 10 weight percent, preferably equal to or less than 6 weight percent, more preferably equal to or less than 4 weight percent, still more preferably equal to or less than 3 weight percent, and optimally, 0 weight percent of the undercoating layer.

The rate of volumetric shrinkage of the undercoating layer before and after curing of the radiation-curable compound is desirably as low as possible. For example, equal to or less than 20 percent is desirable, equal to or less than 15 percent is preferred, equal to or less than 12 percent is of greater preference, and equal to or less than 10 percent is of still greater preference. When the rate of volumetric shrinkage of the undercoating layer exceeds 20 percent, it sometimes becomes difficult to bring about capping of the magnetic recording medium so that the side on which the magnetic layer is present becomes convex.

In the magnetic recording medium of the present invention, the indentation hardness of the undercoating layer is lower than the indentation hardness of the nonmagnetic support. The indentation hardness of the undercoating layer is desirably lower than the indentation hardness of the nonmagnetic support under the environmental conditions in which the information is inputted and outputted by the drive system. Specifically, the indentation hardness of the undercoating layer is desirably lower than that of the nonmagnetic support under environmental conditions of a temperature range of 0 to 50° C. and a relative humidity of 5 to 95 percent, preferably under environmental conditions of a temperature of 5 to 45° C. and a relative humidity of 5 to 90 percent, and more preferably, under environmental conditions of a temperature range of 5 to 40° C. and a relative humidity of 10 to 80 percent.

In the present invention, the “indentation hardness” can be measured by known methods. An example of a method of measuring the indentation hardness is given below. The measurement is desirably conducted under the environmental conditions under which information is inputted and outputted by the drive system, as set forth above. The indentation hardness generally somewhat varies based on the temperature and humidity conditions. However, for example, a magnetic recording medium in which the indentation hardness of the undercoating layer is lower than that of the nonmagnetic support under measurement conditions of 5° C. and 40° C. (50 percent relative humidity) can afford desired properties under the environmental conditions under which information is inputted and outputted by the drive system.

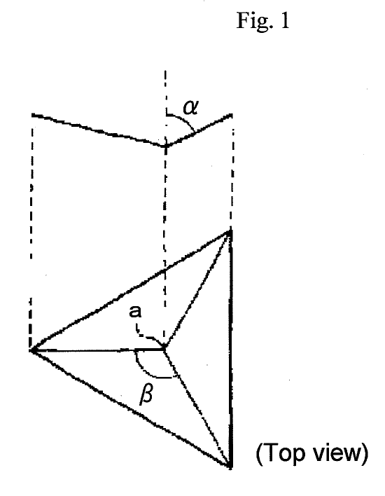

For example, as shown in FIG. 1, the indentation hardness can be measured on the basis of the loading-unloading curve when a diamond indenter, having a triangular pyramidal shape in which the radius of curvature at tip a is 100 nm, the edge angle (α) is 65°, and the adjacent edge angle (β) is 115° C., is pressed into the undercoating layer or nonmagnetic support at a load of 6 mgf. When an indenter of this specific shape is pressed into the undercoating layer or nonmagnetic support with a load of 6 mgf, the indentation hardness characteristic of the undercoating layer can be measured without the tip a of the indenter reaching a depth of 0.1 micrometer from the surface of the undercoating layer.

Indenters of this shape are known as Verkovich indenters. For example, an Elionix Co., Ltd. nanoindentation hardness tester (model No.: ENT-1100a) or the like equipped with a Verkovich indenter can be employed as a measurement device at a load of 6 mgf.

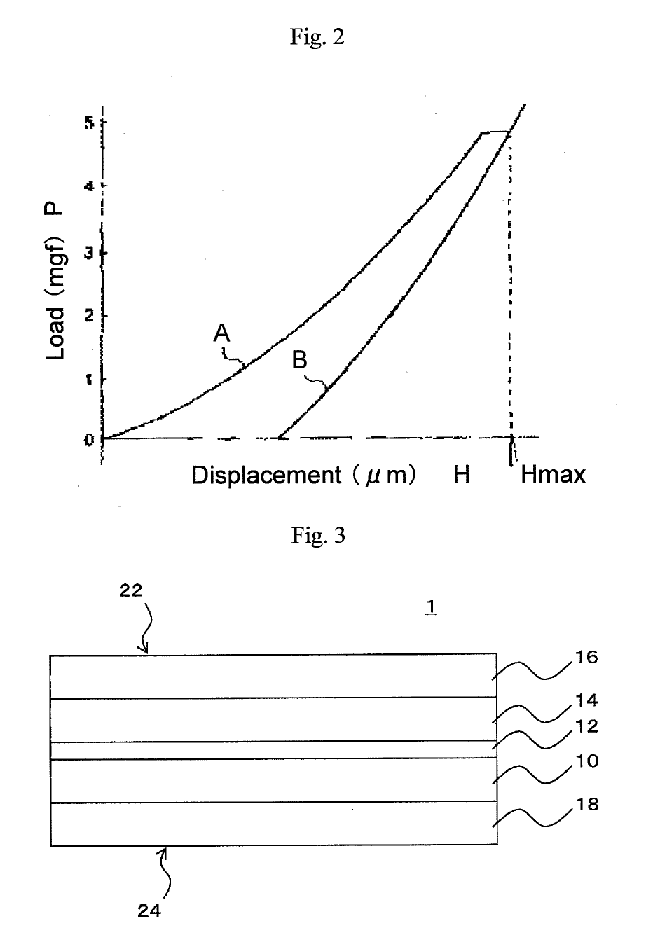

FIG. 2 shows loading-unloading curves indicating the amount of displacement of a Verkovich indenter when the load is continuously increased to press a Verkovich indenter into a sample, up to the point where the load reaches 6 mgf. In FIG. 2, as the load increases, the displacement increases, as shown by curve A; the maximum amount of displacement (Hmax) is exhibited at 6 mgf. When the load is removed, the amount of displacement gradually decreases, as shown by curve B. The indentation hardness (DH) is calculated by equation (1) below from the maximum displacement (Hmax) thus obtained and the maximum load (Pmax=6 mgf).

$$\begin{matrix}DH = 3.7926 \times {10}^{- 2} \{ P max / {( H max )}^{2} \} ( kg \text{/} {mm}^{2} ) \\ = 0.37 \{ P max / {( H max )}^{2} \} ( MPa )\end{matrix} \qquad ( 1 )$$

(where Pmax denotes the maximum load and Hmax denotes the maximum displacement)

The means of adjusting the indentation hardness of the undercoating layer is not specifically limited. Adjusting the type of radiation-curable compound employed in the undercoating layer, adjusting the degree of crosslinking and polymerization of the radiation-curable compound, and the like are effective.

The indentation hardness of the undercoating layer is desirably 30 to 90 percent, preferably 40 to 80 percent, and more preferably, 50 to 80 percent the indentation hardness of the nonmagnetic support. When the indentation hardness is excessively low, handling properties in the manufacturing process deteriorate. Conversely, when the indentation hardness is excessively high, the effect of the undercoating layer suitably absorbing the high pressure exerted locally due to contact between the magnetic layer and the head and the effect of depressing the abrasive and carbon black are lost.

The indentation hardness of the undercoating layer can be determined based on the indentation hardness of the nonmagnetic support. An indentation hardness of 147 to 441 MPa (about 15 to 45 kg/mm²) is desirable, 196 to 392 MPa (about 20 to 40 kg/mm²) is preferred, and 245 to 343 MPa (about 25 to 35 kg/mm²) is of greater preference. For example, when the nonmagnetic support is polyethylene-2,6-naphthalene dicarboxylate (PEN), an undercoating layer having an indentation hardness within the above-stated range is desirably formed.

The thickness of the undercoating layer is desirably equal to or less than 2.0 micrometers, preferably 0.05 to 1.0 micrometer, more preferably 0.1 to 0.7 micrometer, and still more preferably, 0.2 to 0.5 micrometer. When the undercoating layer is equal to or less than 2.0 micrometers in thickness, the handling properties of the support on which the undercoating layer is provided are good. Additionally, when the thickness of the undercoating layer is equal to or greater than 0.05 micrometer, the effect of the surface properties of the nonmagnetic support on the surface properties of the magnetic layer can be reduced, and a good effect in suitably absorbing the high pressure locally exerted due to contact between the magnetic layer and the magnetic head and a good effect in depressing abrasive and carbon black can be achieved.

The glass transition temperature Tg of the undercoating layer is desirably −40 to 80° C., preferably −10 to 60° C. When the glass transition temperature Tg of the undercoating layer is within the above-stated range, the desired flexibility can be imparted to the undercoating layer.

Since the possibility of protrusions forming on the surface of the magnetic layer is increased by incorporating particles in the undercoating layer, the undercoating layer desirably incorporates essentially no particles comprised of organic or inorganic compounds.

That is, in the magnetic recording medium of the present invention, the undercoating layer is desirably a layer comprised of a radiation-curable compound that has been cured by irradiation with radiation.

### Carbonic Ester

The magnetic recording medium of the present invention comprises a carbonic ester denoted by general formula (1) in at least one of a magnetic layer and a nonmagnetic layer.

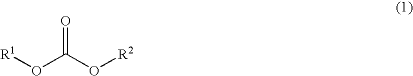

In general formula (1), each of R¹ and R² independently denotes a saturated hydrocarbon group, with a total number of carbon atoms in R¹ and R² being equal to or higher than 12 but equal to or lower than 50.

The carbonic ester denoted by general formula (1) can function as a lubricant. The lubricating property of the carbonic ester denoted by general formula (1) is affected by the number of carbon atoms in R¹ and R²; a desirable lubricating property tends not to be achieved when the number of carbon atoms is excessively high or low. In general formula (1), the total number of carbon atoms in R¹ and R² is equal to or higher than 12 but equal to or lower than 50. When the sum of the number of carbon atoms in R¹ and R² is equal to or higher than 12, there is little volatility, and when employed as a lubricant in the magnetic recording medium, little lubricant volatizes from the surface of the magnetic layer and stable running durability can be achieved. When the sum of the number of carbon atoms in R¹ and R² is equal to or lower than 50, the molecular displacement property is high and a suitable amount of lubricant seeps out onto the surface of the magnetic layer from the nonmagnetic layer and magnetic layer, achieving stable running durability. The total number of carbon atoms in R¹ and R² is desirably equal to or higher than 12 but equal to or lower than 40, preferably equal to or higher than 14 but equal to or lower than 35, and more preferably, equal to or higher than 16 but not equal to or lower than 30.

In general formula (1), both R¹ and R² are saturated hydrocarbon groups. It is difficult to achieve a good lubricating effect with carbonic esters containing unsaturated hydrocarbon groups.

In general formula (1), at least one from among R¹ and R² desirably denotes a saturated hydrocarbon group having a branched structure. It is preferable for one of the two to denote a saturated hydrocarbon group having a branched structure and for the other to denote a saturated hydrocarbon group having a linear structure. This can lower the melting point of the lubricant and achieve an adequate effect under low-temperature environmental conditions.

The number of carbon atoms of the above saturated hydrocarbon group having a branched structure is desirably equal to or higher than 3 but equal to or lower than 12, preferably equal to or higher than 4 but equal to or lower than 10. The branched structure is desirably present at the β position. Carbonic esters having a branched structure at the β position exhibit relatively low melting points. Thus, they volatize little from the surface of the magnetic layer and can afford stable running durability. The saturated hydrocarbon group having a branched structure is desirably a 2-methylpropyl group, 2-methylbutyl group, or 2-ethylhexyl group.

The number of carbon atoms in the saturated hydrocarbon group having a linear structure is desirably equal to or higher than 8 but equal to or lower than 24, preferably equal to or higher than 10 but equal to or lower than 20, and more preferably, equal to or higher than 12 but equal to or lower than 18. From the perspective of the availability of starting materials, R² desirably comprises 12, 14, 16, or 18 carbon atoms. R² desirably comprises 8 or more carbon atoms from the perspective of molecular orientation to achieve a high lubricating effect, and preferably comprises 12 or more carbon atoms to achieve low volatility and a stable lubricating property. When the number of carbon atoms is equal to or lower than 24, a relatively low melting point can be achieved that is desirable from a practical perspective. The melting point is even lower and stable lubricating properties can be achieved when the number of carbon atoms is equal to or lower than 18. Examples of saturated hydrocarbon groups having a linear structure are butyl, hexyl, octyl, decyl, dodecyl, tetradecyl, hexadecyl, and octadecyl groups.

The melting point of the carbonic ester is desirably equal to or higher than −30° C. but equal to or lower than 50° C., preferably equal to or higher than −20° C. but equal to or lower than 40° C., more preferably equal to or higher than −10° C. but equal to or lower than 30° C., and still more preferably, equal to or higher than −5° C. but equal to or lower than 20° C. The molecular weight of the carbonic ester is desirably equal to or higher than 250 but less than 500, preferably equal to or higher than 300 but less than 480, and more preferably, equal to or higher than 360 but less than 460. Having a molecular weight falling within the above-stated range can make it possible to achieve stable lubricating properties under a variety of environmental conditions.

The carbonic ester (carbonate) compound denoted by general formula (1) can be synthesized by known methods, as well as being commercially available. Examples of synthesis methods are the method of reacting a chloroformic ester with an alcohol, the method of reacting a carbonic ester having a lower hydrocarbon group with an alcohol, the method of reacting a diaryl carbonic ester with an alcohol, the method of using a metal catalyst to react carbon monoxide with an alcohol, and the method of reacting phosgene or a phosgene equivalent, such as triphosgene, with an alcohol. Of these, from the perspective of the ease of introducing two different saturated hydrocarbon groups to synthesize a single carbonic ester, the method of reacting a chloroformic ester with an alcohol having the above-described saturated hydrocarbon group is desirable. The above-stated lower hydrocarbon group indicates a hydrocarbon group in which the number of carbon atoms is lower than that of the saturated hydrocarbon group in the alcohol employed in the reaction.

Specific examples of chloroformic esters that are desirable as starting materials in such a synthesis reaction are methyl chloroformate, ethyl chloroformate, butyl chloroformate, sec-butyl chloroformate, isobutyl chloroformate, propyl chloroformate, isopropyl chloroformate, 2-ethylhexyl chloroformate, 2-methylpropyl chloroformate, and 2-methylbutyl chloroformate.

The temperature employed in the synthesis reaction is not specifically limited other than that it be a temperature at which the reaction will progress. A range of equal to or higher than 0° C. to equal to or lower than 60° C. is desirable, equal to or higher than 0° C. to equal to or lower than 40° C. is preferable, and equal to or higher than 0° C. to equal to or lower than 25° C. is even more preferable. The reaction may be conducted under conditions of reduced pressure or ordinary pressure, but conducting it under conditions of ordinary pressure is desirable from the perspective of inexpensive manufacturing.

A catalyst may be employed in the synthesis reaction. When a catalyst is employed, the quantity of catalyst is desirably equivalent to 0.001 to 1.0 percent of the carbonate reactive groups of the chloroformic ester compound, carbonic ester comprising a lower hydrocarbon or aryl group, or phosgene serving as starting material.

Examples of such catalysts are: organic bases such as pyridine, 4-dimethylaminopyridine, 2-methylpyridine, 4-methylpyridine, imidazole, N-methylimidazole, N-methylmorpholine, and benzotriazole; metal hydroxides such as lithium hydroxide, calcium hydroxide, and magnesium hydroxide; carbonates such as lithium carbonate, sodium carbonate, potassium carbonate, and cerium carbonate; and hydrogen carbonates such as sodium hydrogencarbonate and potassium hydrogencarbonate. Pyridine, 4-dimethylaminopyridine, 2-methylpyridine, 4-methylpyridine, N-methylimidazole, benzotriazole, and other organic bases not having N—H bonds when neutral, as well as lithium hydroxide, are desirable. Of these, pyridine, 4-dimethylaminopyridine, 2-methylpyridine, 4-methylpyridine, and other pyridines and their derivatives are preferred.

The carbonic ester (carbonate) compound denoted by general formula (1) can be recovered from the reaction solution by a method such as extraction, distillation, crystallization, or some other separation method. From the perspective of industrial productivity, the use of an extraction method is desirable. The solvent employed in extraction will be described below.

Since the above carbonic ester is highly soluble in saturated hydrocarbon solvents, the use of a solvent, including an organic solvent, that is incompatible with saturated hydrocarbon solvents as the solvent (extraction solvent) that is separated from the saturated hydrocarbon solvent is desirable. Use of the above extraction solvent and a saturated hydrocarbon solvent in liquid-liquid extraction is desirable as the extraction method. The solvent employed in extraction must dissolve impurities, and is desirably a solvent having a high degree of compatibility with water to remove the bases and the like employed in the reaction.

The saturated hydrocarbon solvent employed in the present invention is not specifically limited other than that it dissolve the carbonic ester employed in the present invention. From the perspectives of solvent handling and ease of the separation operation, a saturated hydrocarbon solvent with a boiling point of 35 to 85° C. is desirable; heptane, hexane, or a mixture of these solvents is preferred; and hexane is of greater preference. Saturated hydrocarbon solvents may be employed singly, or combined for use in any desired ratio.

Due to extremely low solubility in water, it is sometimes necessary to remove as an impurity any of the alcohol, serving as a starting material of the carbonic ester, that remains within the reaction system as an unreacted component. Thus, solvents including methanol, ethanol, propanol, acetonitrile, ethylene glycol, and/or propylene glycol are desirable, and methanol and/or acetonitrile is preferred, as a specific extraction solvent.

In addition to employing one of the above-described solvents singly, mixed solvents that are capable of removing by-products and residual impurities from the reaction system of the saturated hydrocarbon solvent can be employed. Specifically, mixed solvents of methanol and water, acetonitrile and water, propylene glycol and water, and methanol and ethylene glycol are desirable.

The above carbonic ester can be incorporated into either the magnetic layer or the nonmagnetic layer, or both. The carbonic ester can be employed singly or in combinations of two or more.

The content of the carbonic ester in the magnetic layer can be, for example, 0.1 to 5.0 weight percent; is desirably 0.5 to 3.0 weight percent; and is preferably 0.7 to 2.0 weight percent.

Incorporating the carbonic ester into the nonmagnetic layer can cause the carbonic ester in the nonmagnetic layer to gradually migrate to the magnetic layer side during running and during storage, making it possible to control the quantity seeping out onto the surface. This is advantageous in terms of maintaining good running durability. In this case, for example, it is possible to control seepage onto the surface by employing carbonic esters of different melting points in the nonmagnetic layer and the magnetic layer; to control seepage out onto the surface by employing esters of different boiling points or polarities; to control seepage out onto the surface by regulating the quantity of surfactant; and to control the quantity of carbonic ester present on the surface of the magnetic layer during running and during storage by increasing the quantity of carbonic ester added to the nonmagnetic layer.

The content of carbonic ester in the nonmagnetic layer is, for example, 0.5 to 5.0 weight percent, preferably 0.7 to 4.0 weight percent, and more preferably, 1.0 to 3.0 weight percent.

The magnetic recording medium of the present invention will be described in greater detail below with reference to the drawings.

FIG. 3 is a sectional view of a magnetic recording medium relating to an implementation embodiment of the present invention. Magnetic recording medium 1 is comprised of a nonmagnetic support 10, a backcoat layer 18 formed on the rear tape surface of nonmagnetic support 10, and, sequentially provided on the front surface side of nonmagnetic support 10, an undercoating layer 12, a nonmagnetic layer 14, and a magnetic layer 16. Thus, undercoating layer 12, nonmagnetic layer 14, and magnetic layer 16 are provided on the opposite side of nonmagnetic support 10 from backcoat layer 18, with magnetic layer 16 constituting the tape front surface 22 and backcoat layer 18 constituting the tape rear surface 24.

As set forth above, the undercoating layer 12 employed in magnetic recording medium 1 comprises a radiation-curable compound that has been cured by irradiation with radiation and has a lower indentation hardness than the nonmagnetic support. Further, at least one from among nonmagnetic layer 14 and magnetic layer 16 comprises a carbonic ester denoted by general formula (1).

As set forth further below, the thickness of nonmagnetic layer 14 is desirably 0.1 to 2.0 micrometers.

As set forth further below, the surface resistivity of magnetic layer 16 is desirably 1×10⁴ to 1×10⁸ Ω/□. To achieve a surface resistivity in magnetic layer 16 falling within the above-stated range, an electrically conductive polymer compound is desirably incorporated into at least one from among undercoating layer 12, nonmagnetic layer 14, and magnetic layer 16. The details of the electrically conductive polymer compound will be described below.

The magnetic recording medium of the present invention is preferably manufactured as set forth below. That is, an undercoating layer coating liquid comprising a radiation-curable compound is coated on a nonmagnetic support, the undercoating layer coating liquid is dried, and the radiation-curable compound is cured by irradiation with radiation to form an undercoating layer. Subsequently, a nonmagnetic layer coating liquid is coated on the undercoating layer and the nonmagnetic layer coating liquid is dried to form a nonmagnetic layer over the undercoating layer. Subsequently, a magnetic layer coating liquid is coated on the nonmagnetic layer and the magnetic layer coating liquid is dried to form a magnetic layer on the nonmagnetic layer. Such a sequential multilayering method is highly desirable because it can prevent adjacent layers from intermixing. For example, when the nonmagnetic layer and the magnetic layer are manufactured by a simultaneous multilayering method, intermixing tends to occur at the boundary between the nonmagnetic layer and the magnetic layer. In a magnetic recording medium in which a particularly thin magnetic layer is provided, the intermixing at the boundary results in deterioration of electromagnetic characteristics and lowers the yield. By contrast, when the magnetic recording medium is formed by the sequential multilayering method, intermixing at the boundary between the nonmagnetic layer and the magnetic layer can be reduced and electromagnetic characteristics and the yield can be improved. The present inventor has determined that even in a magnetic recording medium manufactured by the sequential multilayering coating method, in the same manner as in a magnetic recording medium manufactured by the simultaneous multilayering coating method, the quantity of carbonic ester contained in the nonmagnetic layer that gradually migrates to the magnetic layer side during running and during storage and seeps out onto the surface can be controlled. Accordingly, incorporating the above carbonic ester into the nonmagnetic layer is advantageous for maintaining good running durability in both a magnetic recording medium manufactured by the sequential multilayering method and a magnetic recording medium manufactured by the simultaneous multilayering method.

In a magnetic recording medium formed by the sequential multilayering method, there is little intermixing between the nonmagnetic layer and the magnetic layer. Thus, it is possible to observe the fact that the composition differs clearly at the boundary of the nonmagnetic layer and magnetic layer by etching the magnetic recording medium from the surface of the magnetic layer (tape surface) in the direction of depth to analyze the composition. By contrast, in a magnetic recording medium formed by the simultaneous multilayering method, due to intermixing at the boundary of the nonmagnetic layer and the magnetic layer, no clear difference in composition is observed at the boundary between the nonmagnetic layer and magnetic layer even when the same analysis is conducted. Accordingly, it is possible to readily distinguish a medium that has been formed by the simultaneous multilayering method from a medium that has been formed by the sequential multilayering method.

When an identical coating liquid is employed to form magnetic layers of identical thickness, the level of variation at the boundary between the nonmagnetic layer and the magnetic layer will be lower in a magnetic recording medium formed by the sequential multilayering method than in a magnetic recording medium formed by the simultaneous multilayering method. Accordingly, it is possible to distinguish a medium that has been formed by the sequential multilayering method from a medium that has been formed by the simultaneous multilayering method based on the difference in variation at the boundary between the nonmagnetic layer and the magnetic layer. By way of example, boundary variation between the nonmagnetic recording layer and the magnetic recording layer of a tape-shaped magnetic recording medium can be measured by the following method.

The longitudinal section of a magnetic recording medium (tape) is observed at 100,000-fold magnification with a transmission electron microscope (TEM). In the course of cutting the magnetic recording medium to form the section, epoxy resin can be used to envelope the magnetic recording medium. A section of the magnetic recording medium 10 micrometers in length is analyzed with an image analyzer, the thickness of the magnetic layer d and the standard deviation σ are obtained, and the boundary variation rate Da between the nonmagnetic layer and the magnetic layer can be calculated by the equation Da=(σ/d)×100 (%).

The magnetic recording medium of the present invention is desirably employed in a drive system for high-density recording. Normally, an MR head is employed in such a drive system. The magnetic recording medium of the present invention is desirably employed in a drive system in which an MR head has been mounted.

The individual layers constituting the magnetic recording medium of the present invention will be described in detail below.

### (Nonmagnetic Support)

In the magnetic recording medium of the present invention, the indentation hardness of the undercoating layer is lower than that of the nonmagnetic support. For example, when measuring the indentation hardness of the nonmagnetic support by the above-described indentation hardness measurement method, to maintain the strength and flexibility of the medium, the indentation hardness of the nonmagnetic support is desirably 343 to 588 MPa (about 35 to 60 kg/mm²), preferably 392 to 539 MPa (about 40 to 55 kg/mm²).

A known nonmagnetic support in the form of a polyester support such as polyethylene terephthalate or polyethylene naphthalate, a polyolefin support, cellulose triacetate, polycarbonate, polyamide, polyimide, polyamide-imide, polysulfone, aromatic polyamide, polybenzoxazole, or the like may be employed as the nonmagnetic support. The use of a high-strength nonmagnetic support such as polyethylene terephthalate, polyethylene naphthalate, or aramid is desirable. Nonmagnetic supports can be single layer or multilayered types, such as those described in Japanese Unexamined Patent Publication (KOKAI) Heisei No. 3-224127, which is expressly incorporated herein by reference in its entirety. Either type may be employed in the present invention.

The support employed in the present invention is desirably inexpensive. Accordingly, it is preferable to employ a polyester support as the nonmagnetic support in the present invention.

Polyester is a polymer obtained by polycondensation of an aromatic dicarboxylic acid such as terephthalic acid or 2,6-naphthalene dicarboxylic acid, with an aliphatic glycol such as ethylene glycol, diethylene glycol, or 1,4-cyclohexane dimethanol. In addition to a homopolymer, the polymer may also be a copolymer in which a third component has been incorporated. In that case, one or more dicarboxylic acid components in the form of, for example, isophthalic acid, phthalic acid, terephthalic acid, 2,6-naphthalene dicarboxylic acid, adipic acid, sebacic acid, and oxycarboxylic acid (such as p-oxybenzoic acid) may be employed. One or more glycol components in the form of ethylene glycol, propylene glycol, butanediol, 1,4-cyclohexane dimethanol, neopentyl glycol, diethylene glycol, or triethylene glycol, may be employed.

A polyester support comprising a main component in the form of polyethylene terephthalate (PET) or polethylene-2,6-naphthalene dicarboxylate (PEN), is desirably employed in the present invention. When employing PET or PEN as main component in the nonmagnetic support, a polymer obtained by copolymerizing equal to or more than 5 mol percent, relative to the total acid component or total glycol component, of a third component selected from among isophthalic acid, terephthalic acid, 2,6-napthalene dicarboxylic acid, 1,4-cyclohexane dimethanol, 1,4-butanediol, and diethylene glycol is desirably employed as the main component of the nonmagnetic support.

The glass transition temperature of the main component of the nonmagnetic support is desirably equal to or higher than 100° C. From this perspective, PEN is optimal. Desirable examples of nonmagnetic supports employing PEN as main component are described in Japanese Unexamined Patent Publication (KOKAI) Nos. 2005-329548 and 2005-330311, which are expressly incorporated herein by reference in their entirety.

The thickness of the nonmagnetic support is desirably kept as low as possible to manufacture a high-capacity magnetic recording medium. The support employed in the present invention desirably has a thickness of equal to or less than 10 micrometers, preferably 2 to 8 micrometers, more preferably 3 to 7 micrometers, and still more preferably, 4 to 6 micrometers. A support equal to or more than 2 micrometers in thickness can prevent breaking of the magnetic recording medium during use. A support equal to or less than 10 micrometers in thickness can yield a high-capacity magnetic recording medium.

The surface roughness of the nonmagnetic support employed in manufacturing the magnetic recording medium is normally adjusted by incorporating inactive microparticles such as kaolin, talc, titanium dioxide, silicon dioxide (silica), calcium phosphate, aluminum oxide, zeolite, lithium fluoride, calcium fluoride, barium sulfate, carbon black, or the heat-resistant polymer micropowder described in Japanese Examined Patent Publication (KOKOKU) Showa No. 59-5216, which is expressly incorporated herein by reference in its entirety, into the nonmagnetic support. Inactive microparticles with a narrow particle size distribution are desirable.

The center line average surface roughness (Ra) of the surface of the nonmagnetic support employed in the present invention (the surface on the side on which the magnetic layer is provided) is desirably equal to or greater than 1 nm and equal to or less than 50 nm, preferably equal to or greater than 1 nm and equal to or less than 25 nm, more preferably equal to or greater than 2 nm and equal to or less than 15 nm, and still more preferably, equal to or greater than 3 nm and equal to or less than 10 nm. When the center line average surface roughness (Ra) of the surface of the support is less than 1 nm, the handling properties of the magnetic recording medium during the manufacturing process may deteriorate. A center line average surface roughness (Ra) of the surface of the support that exceeds 50 nm is undesirable in that the undercoating layer becomes extremely thick, making it necessary to prevent the support from affecting the surface properties of the magnetic layer.

The center line average surface roughness of the support can be measured, for example, with the NewView series of general-purpose three-dimensional surface structure analyzers made by Zygo Corporation.

The thermal shrinkage rate of the support employed in the present invention before and after being placed for 30 minutes under environmental conditions of 100° C. is desirably equal to or less than 3 percent, preferably equal to or less than 1.5 percent. The thermal contraction rate before and after placing the support for 30 minutes under environmental conditions of 80° C. is desirably equal to or less than 1 percent, preferably equal to or less than 0.5 percent. The breaking strength of the support is desirably 5 to 100 kg/mm² (about 49 to 980 MPa), and the modulus of elasticity of the support is desirably 100 to 2,000 kg/mm² (about 0.98 to 19.6 GPa). The temperature expansion coefficient of the support is desirably 10⁻⁴ to 10⁻⁸/° C., preferably 10⁻⁵ to 10⁻⁶/° C. The humidity expansion coefficient of the support is desirably equal to or lower than 10⁻⁴/relative humidity %, preferably equal to or lower than 10⁻⁵/relative humidity %. These thermal characteristics, dimensional characteristics, and mechanical strength characteristics of the support are desirably roughly equal in the various in-plane directions; specifically, a difference of not greater than 10 percent is desirable.

The support can also be subjected to various treatments such as corona discharge treatment, plasma treatment, heat treatment, or dust removal treatment.

### (Magnetic Layer)

Hexagonal ferrite powder and ferromagnetic metal powder are examples of the ferromagnetic powder contained in the magnetic layer.

Examples of hexagonal ferrite powders suitable for use in the present invention are barium ferrite, strontium ferrite, lead ferrite, calcium ferrite, and various substitution products thereof, and Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sn—Zn—Co, and Nb—Zn have been added may generally also be employed. They may comprise specific impurities depending on the starting materials and manufacturing methods employed.

The particle size, as a hexagonal plate diameter, preferably ranges from 10 to 100 nm, more preferably 10 to 60 nm, further preferably 10 to 50 nm. Particularly when employing an MR head in reproduction to increase a track density, a plate diameter equal to or less than 40 nm is desirable to reduce noise. A plate diameter equal to or higher than 10 nm yields stable magnetization without the effects of thermal fluctuation. A plate diameter equal to or less than 100 nm permits low noise and is suited to the high-density magnetic recording. The plate ratio (plate diameter/plate thickness) of the hexagonal ferrite powder preferably ranges from 1 to 15, more preferably from 1 to 7. Low plate ratio is preferable to achieve high filling property of the magnetic layer, but sometimes adequate orientation is not achieved. When the plate ratio is higher than 15, noise may be increased due to stacking between particles. The specific surface area by BET method of the hexagonal ferrite powders having such particle sizes ranges from 10 to 100 m²/g, almost corresponding to an arithmetic value from the particle plate diameter and the plate thickness. Narrow distributions of particle plate diameter and thickness are normally good. Although difficult to render in number form, about 500 particles can be randomly measured in a transmission electron microscope (TEM) photograph of particles to make a comparison. This distribution is often not a normal distribution. However, when the distribution is expressed as the standard deviation σ to the average particle size, a/average particle size=0.1 to 2.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of about 500 to 5,000 Oe (about 40 to 398 kA/m) can normally be achieved. A high coercivity (Hc) is advantageous for high-density recording, but this is limited by the capacity of the recording head. The hexagonal ferrite powder employed in the present invention preferably has a coercivity (Hc) ranging from 2,000 to 4,000 Oe (about 160 to 320 kA/m), more preferably 2,200 to 3,500 Oe (about 176 to 280 kA/m). When the saturation magnetization of the head exceeds 1.4 tesla, the hexagonal ferrite having a coercivity (Hc) of equal to or higher than 2,200 Oe (about equal to or higher than 176 kA/m) is preferably employed. The coercivity (Hc) can be controlled by particle size (plate diameter and plate thickness), the types and quantities of elements contained, substitution sites of the element, the particle producing reaction conditions, and the like. The saturation magnetization (σₛ) can be 40 to 80 A·m²/kg. The higher saturation magnetization (σₛ) is preferred, however, it tends to decrease with decreasing particle size. Known methods of improving saturation magnetization (σₛ) are combining spinel ferrite with magnetoplumbite ferrite, selection of the type and quantity of elements incorporated, and the like. It is also possible to employ W-type hexagonal ferrite. When dispersing the hexagonal ferrite powder, the surface of the hexagonal ferrite powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added can range from 0.1 to 10 weight percent relative to the weight of the hexagonal ferrite powder. The pH of the hexagonal ferrite powder is also important to dispersion. A pH of about 4 to 12 is usually optimum for the dispersion medium and polymer. From the perspective of the chemical stability and storage properties of the medium, a pH of about 6 to 11 can be selected. Moisture contained in the hexagonal ferrite powder also affects dispersion. There is an optimum level for the dispersion medium and polymer, usually selected from the range of 0.01 to 2.0 weight percent. Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to 100° C. or greater; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. However, any manufacturing method can be selected in the present invention.

The ferromagnetic metal powder employed in the magnetic layer is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

These ferromagnetic metal powders may be pretreated prior to dispersion with dispersing agents, lubricants, surfactants, antistatic agents, and the like, described further below. Specific treatment examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014, which are expressly incorporated herein by reference in their entirety.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Ferromagnetic metal powders thus obtained can be subjected to slow oxidation by a known method of slow oxidation, for example, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film.

The specific surface area by BET method of the ferromagnetic metal powder employed in the magnetic layer is preferably 45 to 100 m²/g, more preferably 50 to 80 m²/g. At 45 m²/g and above, low noise is achieved. At 100 m²/g and below, good surface properties are achieved. The crystallite size of the ferromagnetic metal powder is preferably 80 to 180 Angstroms, more preferably 100 to 180 Angstroms, and still more preferably, 110 to 175 Angstroms. The major axis length of the ferromagnetic metal powder is preferably equal to or greater than 0.01 micrometer and equal to or less than 0.15 micrometer, more preferably equal to or greater than 0.02 micrometer and equal to or less than 0.15 micrometer, and still more preferably, equal to or greater than 0.03 micrometer and equal to or less than 0.12 micrometer. The acicular ratio of the ferromagnetic metal powder is preferably equal to or greater than 3 and equal to or less than 15, more preferably equal to or greater than 5 and equal to or less than 12. The σₛ of the ferromagnetic metal powder is preferably 90 to 180 A·m²/kg, more preferably 100 to 150 A·m²/kg, and still more preferably, 105 to 140 A·m²/kg. The coercivity of the ferromagnetic powder is preferably 2,000 to 3,500 Oe (about 160 to 280 kA/m), more preferably 2,200 to 3,000 Oe (about 176 to 240 kA/m).

The moisture content of the ferromagnetic metal powder is desirably 0.01 to 2 percent. The moisture content of the ferromagnetic metal powder is desirably optimized based on the type of binder. The pH of the ferromagnetic metal powder is desirably optimized depending on the type of binder employed together. A pH range of 4 to 12 can be established, with 6 to 10 being preferred. As needed, the ferromagnetic metal powder can be surface treated with Al, Si, P, or an oxide thereof. The quantity of surface treatment can be set to 0.1 to 10 percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present in the ferromagnetic metal powder, but seldom affect characteristics at 200 ppm or less. The ferromagnetic metal powder employed in the present invention desirably has few voids; the void level is preferably 20 volume percent or less, more preferably 5 volume percent or less. As stated above, so long as the particle size characteristics are satisfied, the ferromagnetic metal powder may be acicular, rice grain-shaped, or spindle-shaped. The SFD of the ferromagnetic metal powder itself is desirably low, with 0.8 or less being preferred. The coercivity (Hc) distribution of the ferromagnetic metal powder is desirably kept low. When the SFD is 0.8 or lower, good electromagnetic characteristics are achieved, output is high, and magnetic inversion is sharp, with little peak shifting, in a manner suited to high-density digital magnetic recording. To keep the coercivity (Hc) distribution low, the methods of improving the particle size distribution of goethite in the ferromagnetic metal powder and preventing sintering may be employed.

From the perspectives of the microdispersion suitability and durability suitability (environmental suitability to temperature and humidity) of ferromagnetic powder particles, a polyurethane resin, polyester resin, or cellulose acetate is desirably employed as the binder in the magnetic layer; a polyurethane resin or polyester resin is preferred; and a polyurethane resin is optimal. The structure of the polyurethane resin is not specifically limited; known structures such as polyester polyurethanes, polyether polyurethanes, polyether polyester polyurethanes, polycarbonate polyurethanes, polyester polycarbonate polyurethanes, and polycaprolactones may be employed.

A resin with a weight average molecular weight (Mw) of equal to or higher than 120,000 is desirably incorporated as a constituent component of the binder. When manufacturing a magnetic recording medium by the sequential multilayering method that is suitable for use in the presentinvention, the ferromagnetic powder particles sometimes aggregate (orientation aggregation) during the magnetic field orientation treatment following coating of the magnetic layer coating liquid. Orientation aggregation becomes particularly pronounced when a magnetic layer coating liquid of low concentration is employed to form a thin magnetic layer. This is because the lower the concentration, the more readily the ferromagnetic powder particles are displaced by the magnetic force during orientation processing, tending to cause orientation aggregation.

Orientation aggregation can be reduced or eliminated by employing a binder component containing a constituent component in the form of a resin with a weight average molecular weight (Mw) of equal to or higher than 120,000—which is a higher molecular weight than that of the resins conventionally employed as binders in magnetic recording media—as the binder in the magnetic layer.

Resins having such a molecular weight can be adsorbed to a high degree on ferromagnetic powder particles. Thus, using such a resin as a component of the magnetic layer coating liquid can increase the level of adsorption of the binder on the ferromagnetic powder particles in the magnetic layer coating liquid. This increased level of adsorption of binder can increase the stereorepulsion between ferromagnetic powder particles in the magnetic layer coating liquid, and is thus thought to inhibit orientation aggregation of ferromagnetic powder particles during orientation processing. It is also possible to combine multiple resins having weight average molecular weights of equal to or higher than 120,000 for use in the binder.

The weight average molecular weight of the binder can be determined by gel permeation chromatography (GPC), for example.

When considering solubility and ease of synthesis, the weight average molecular weight of the resin is desirably equal to or lower than 500,000, preferably 120,000 to 300,000, and more preferably, 150,000 to 250,000.

The magnetic layer desirably comprises equal to or more than 2.5 weight percent of the above resin having a weight average molecular weight (Mw) of equal to or higher than 120,000 relative to the ferromagnetic powder. That is, the magnetic recording medium of the present invention is desirably formed using a magnetic layer coating liquid containing equal to or more than 2.5 weight percent of the above resin relative to the ferromagnetic powder. In a magnetic layer coating liquid containing equal to or more than 2.5 weight percent of the above resin relative to the ferromagnetic powder, a large amount of binder can adsorb onto the ferromagnetic powder, effectively inhibiting orientation aggregation. The quantity of the above resin in the magnetic layer is desirably 4 to 40 weight percent, preferably 5 to 30 weight percent, and more preferably, 5 to 25 percent, relative to the ferromagnetic powder.

The above resin preferably has a glass transition temperature ranging from −50 to 150° C., more preferably 0 to 100° C., and further preferably, 30 to 90° C. In the above resin, the elongation at break is preferably 100 to 2,000 percent, the stress at break is preferably 0.05 to 10 kg/mm² (about 0.49 to 98 MPa), and the yield point is preferably 0.05 to 10 kg/mm² (about 0.49 to 98 MPa). The above resin can be synthesized by known methods, and is also commercially available.

The above binder component can consist of the above resin. That is, the above binder component can be the above resin. The above binder component can also be a reaction product of the above resin and a compound having a thermosetting functional group. The magnetic recording medium of the present invention is preferably formed by forming a nonmagnetic layer on a nonmagnetic support and then coating and drying a magnetic layer coating liquid thereover. When a magnetic layer is formed by adding the above resin without adding a compound having a thermosetting functional group to the above magnetic layer coating liquid, a magnetic recording medium containing the above resin as the above binder component is obtained. Further, when a compound having a thermosetting functional group is added along with the above resin to the magnetic layer coating liquid, a curing reaction (crosslinking reaction) can be induced by heating (calendering, heat treatment, or the like) following coating, yielding a magnetic recording medium containing the reaction product of the above resin and a compound having a thermosetting functional group as the above binder component. As set forth further below, when adding a resin component in addition to the above resin and compound having a thermosetting functional group to the magnetic layer coating liquid, a copolymer of the above resin, a compound containing a thermosetting functional group, and the additional resin component can be obtained.

The use of a component comprising a thermosetting functional group in the form of an isocyanate group as the above compound containing a thermosetting functional group is desirable. Of these, polyisocyanates are desirable as the above compound. Isocyanates such as tolylene diisocyanate, 4,4′-diphenylmethane diisocyanate, hexamethylene diisocyanate, xylylene diisocyanate, naphthylene-1,5-diisocyanate, o-toluidene diisocyanate, isophorone diisocyanate, and triphenylmethane triisocyanate; products of these isocyanates and polyalcohols; and polyisocyanates produced by condensation of these isocyanates are suitable for use.

These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used singly or in combinations of two or more by exploiting differences in curing reactivity.

The above binder can contain other binder components in addition to the above-described binder component. Examples of other binder components that may be employed in combination with the above-described binder component are conventionally known thermoplastic resins, thermosetting resins, reactive resins, and mixtures thereof. For example, the glass transition temperature of thermoplastic resins employed in combination is preferably −100 to 200° C., more preferably −50 to 150° C.

Specific examples of thermoplastic resins that can be employed in combination are polymers and copolymers containing structural units in the form of vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal, and vinyl ether; polyurethane resins, various rubber resins, and cellulose esters.

Examples of thermosetting resins and reactive resins that can be employed in combination are phenol resin, epoxy resin, polyurethane cured resin, urea resin, melamine resin, alkyd resin, acrylic reaction resin, formaldehyde resin, silicone resin, epoxy-polyamide resin, mixtures of polyester resin and isocyanate prepolymer, mixtures of polyester polyol and polyisocyanate, and mixtures of polyurethane and polyisocyanate. These resins are described in detail in the “Plastic Handbook” released by Asakura Shoten, which is expressly incorporated herein by reference in its entirety. Known e-beam-setting resins may also be employed in the various layers. Examples of such resins and their manufacturing methods are described in detail in Japanese Unexamined Patent Publication (KOKAI) Showa No. 62-256219, which is expressly incorporated herein by reference in its entirety.

The aforementioned resins may be employed singly or in combination. Preferred resins are combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate. Vinyl chloride resins are particularly preferred. Combining a vinyl chloride resin can further increase dispersion of the ferromagnetic powder, and thus improve electromagnetic properties and effectively reduce soiling of the head.

To achieve better dispersion and durability in any of the binder components suitable for use in the magnetic layer, the use of a binder component in which one or more polar groups selected from the group consisting of —COOM, —SO₃M, —OSO₃M, —P═O(OM)₂, —O—P═O(OM)₂ (wherein M denotes a hydrogen atom or an alkali metal base), OH, NR₂, N⁺R₃ (wherein R denotes a hydrocarbon), epoxy group, SH, and CN has been introduced by copolymerization or addition reaction as needed can be employed. The quantity of the polar group is, for example, 10⁻¹ to 10⁻⁸ mole/g, preferably 10⁻² to 10⁻⁶ mole/g.

Specific examples of the binder components mentioned above are VAGH, VYHH, VMCH, VAGF, VAGD, VROH, VYES, VYNC, VMCC, XYHL, XYSC, PKHH, PKHJ, PKHC, and PKFE from Union Carbide Corporation; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

In the magnetic layer containing the above compound comprising a thermosetting functional group, the above resin and compound undergo a crosslinking reaction when the magnetic layer is heated, yielding a magnetic layer comprising the reaction product of the above resin and compound comprising a thermosetting functional group. Since the magnetic layer thus obtained is of greater film strength than a magnetic layer containing the above resin itself, a magnetic recording medium of greater durability can be obtained. When the magnetic layer contains a compound comprising a thermosetting functional group, the content of such a compound is desirably 5 to 40 weight percent, preferably 10 to 30 weight percent, and more preferably, 15 to 25 weight percent, relative to the total binder contained in the magnetic layer.

As set forth above, the magnetic layer can incorporate other binder components (resin components, compounds containing thermosetting functional groups) in addition to the above resin. The details thereof are as set forth above. To both prevent orientation aggregation and ensure good electromagnetic characteristics by adding the above resin having a weight average molecular weight (Mw) of equal to or higher than 120,000, the quantity of the above resin having a weight average molecular weight (Mw) of equal to or higher than 120,000 is desirably 10 to 80 weight percent, preferably 20 to 60 weight percent, and more preferably, 20 to 40 weight percent, relative to the total binder component. Further, to obtain an effect by adding a binder component, the content of the binder component other than the above resin in the magnetic layer is desirably equal to or higher than 2.5 weight percent, preferably 4 to 40 weight percent, more preferably 5 to 30 weight percent, and still more preferably, 5 to 25 weight percent, relative to the ferromagnetic powder.

The thickness of the magnetic layer in the magnetic recording medium of the present invention, for example, is desirably 10 to 300 nm. Orientation aggregation can be inhibited when forming by sequential multilayering a relatively thin magnetic layer having a thickness within the above-stated range by employing a resin having a weight average molecular weight (Mw) of equal to or higher than 120,000 in the magnetic layer. Thus, a magnetic recording medium with good electromagnetic characteristics can be obtained. The magnetic layer is desirably 30 to 150 nm, preferably 40 to 100 nm, in thickness.

The center line average surface roughness (Ra) of the surface of the magnetic layer is desirably low. The surface roughness of the magnetic layer can be evaluated by an atomic force microscope (AFM). The center line average surface roughness (Ra) of the magnetic layer is desirably equal to or lower than 10.0 nm, preferably 1.0 to 10.0 nm, more preferably 2.0 to 7.0 nm, and still more preferably, 2.5 to 5.0 nm. On the surface of the magnetic layer, the number of surface microprotrusions that are 10 to 20 nm in height is desirably 1 to 500/100 μm², preferably 3 to 250/100 μm², more preferably 5 to 150/100 μm², and still more preferably, 5 to 100/100 μm².

The center line average surface roughness (Ra) of the magnetic layer may be affected by the surface properties of the nonmagnetic support, dispersibility of the ferromagnetic powder in the magnetic layer, and the particle size and quantity of abrasive and carbon black that are added to the magnetic layer.

The center line average surface roughness (Ra) and number of surface microprotrusions of the magnetic layer (magnetic recording medium) can be reduced, for example, by diminishing the effect of the surface properties of the nonmagnetic support on the surface of the magnetic layer by means of an undercoating layer, by improving the microdispersibility of the ferromagnetic powder, by reducing the particle size of the abrasive and carbon black, and/or by reducing the quantities of abrasive and carbon black that are added.

Further, the center line average surface roughness (Ra) and the number of microprotrusions on the surface of the magnetic layer (magnetic recording medium) can be reduced in a calendering step. For example, the center line average surface roughness (Ra) and the number of microprotrusions on the surface of the magnetic layer (magnetic recording medium) can be reduced by increasing the linear pressure, extending the pressure load period, and/or raising the processing temperature.

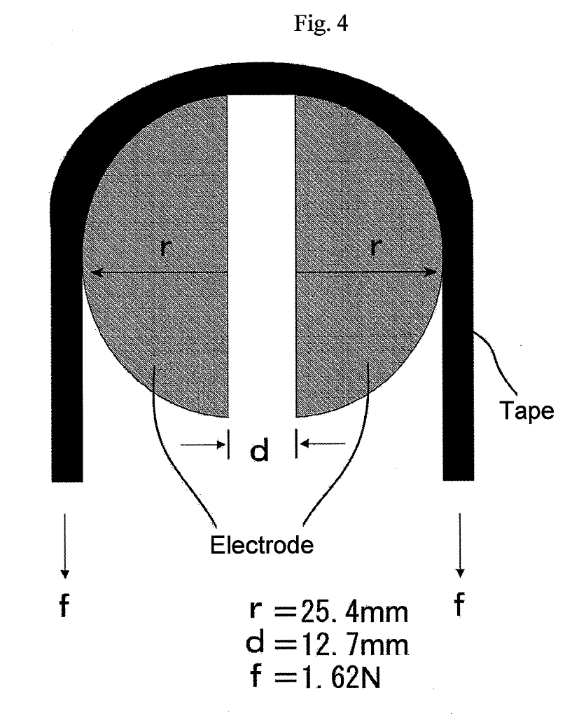

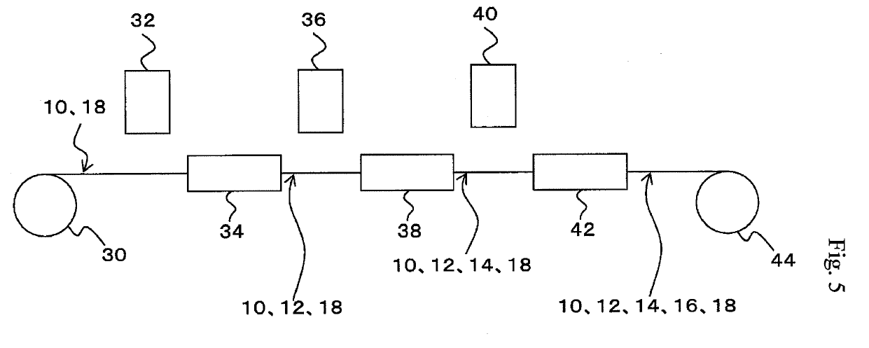

The surface resistivity of the magnetic layer is desirably adjusted to 1×10⁴ to 1×10⁸ Ω/□, preferably to 1×10⁵ to 1×10⁷ Ω/□, more preferably to 1×10⁵ to 5×10⁶ Ω/□, and still more preferably, to 1×10⁵ to 1×10⁶ Ω/□. The surface resistivity of the magnetic layer can be measured using the electrodes shown in FIG. 4.

Charging of the magnetic recording medium, and drop out caused by the adherence of dust and debris due to charging, can be prevented by suitably setting the surface resistivity of the magnetic layer. In particular, since magnetic recording media have a tendency to develop a charge in an atmosphere of low moisture content, such as environmental conditions of low-temperature and low-humidity, it is desirable to adjust the surface resistivity of the magnetic layer as set forth above.

The surface resistivity of the magnetic layer can be adjusted by incorporating a suitable quantity of an electrically conductive material into at least one from among the magnetic layer, nonmagnetic layer, and undercoating layer. It is desirable to add an electrically conductive material to the magnetic layer, or a layer as close as possible to the magnetic layer, to control the surface resistivity of the magnetic layer. Accordingly, the electrically conductive material is desirably added to the magnetic layer or nonmagnetic layer.

Electrically conductive carbon black is widely incorporated into magnetic recording media. However, although the addition of carbon black improves the electrical conductivity of a layer, it also causes deterioration of the surface properties of the layer to which it is added. This effect sometimes results in deterioration of the surface properties of the magnetic layer. In such cases, the electrically conductive polymer compounds described further below are desirably incorporated into the layer to improve the electrical conductivity of the layer.

### (Nonmagnetic Layer)

The nonmagnetic later is a layer comprising at least a nonmagnetic powder and a binder. Details of the nonmagnetic layer will be described below.

The nonmagnetic layer, so long as it is essentially nonmagnetic, is not specifically limited, and may contain magnetic powder to the extent that it remains essentially nonmagnetic. The term “essentially nonmagnetic” means that the nonmagnetic layer may possess magnetism to the extent that the electromagnetic characteristics of the magnetic layer are essentially not diminished. For example, a residual magnetic flux density of equal to or less than 0.01 T or a coercivity of equal to or less than 7.96 kA/m (about 100 Oe) is acceptable, with no residual magnetic flux density or coercivity at all being preferred.

The nonmagnetic powder comprised in the nonmagnetic layer can be selected from inorganic compounds such as metal oxides, metal carbonates, metal sulfates, metal nitrides, metal carbides, metal sulfides and the like. Examples of inorganic compounds are α-alumina having an α-conversion rate of 90 to 100 percent, β-alumina, γ-alumina, θ-alumina silicon carbide, chromium oxide, cerium oxide, α-iron oxide, hematite, goethite, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate and molybdenum disulfide; these may be employed singly or in combination. Particularly desirable are titanium dioxide, zinc oxide, iron oxide and barium sulfate due to their narrow particle distribution and numerous means of imparting functions. Even more preferred is titanium dioxide and α-iron oxide. The particle diameter of these nonmagnetic powders preferably ranges from 0.005 to 2 micrometers, but nonmagnetic powders of differing particle size may be combined as needed, or the particle diameter distribution of a single nonmagnetic powder may be broadened to achieve the same effect. What is preferred most is a particle diameter in the nonmagnetic powder ranging from 0.01 to 0.2 micrometer. Particularly when the nonmagnetic powder is a granular metal oxide, a mean particle diameter equal to or less than 0.08 micrometer is preferred, and when an acicular metal oxide, the major axis length is preferably equal to or less than 0.3 micrometer, more preferably equal to or less than 0.2 micrometer. The tap density preferably ranges from 0.05 to 2 g/ml, more preferably from 0.2 to 1.5 g/ml. The moisture content of the nonmagnetic powder preferably ranges from 0.1 to 5 weight percent, more preferably from 0.2 to 3 weight percent, further preferably from 0.3 to 1.5 weight percent. The pH of the nonmagnetic powder preferably ranges from 2 to 11, and the pH between 5.5 to 10 is particular preferred.

The specific surface area of the nonmagnetic powder preferably ranges from 1 to 100 m²/g, more preferably from 5 to 80 m²/g, further preferably from 10 to 70 m²/g. The crystallite size of the nonmagnetic powder preferably ranges from 0.004 micrometer to 1 micrometer, further preferably from 0.04 micrometer to 0.1 micrometer. The oil absorption capacity using dibutyl phthalate (DBP) preferably ranges from 5 to 100 ml/100 g, more preferably from 10 to 80 ml/100 g, further preferably from 20 to 60 ml/100 g. The specific gravity of the nonmagnetic powder preferably ranges from 1 to 12, more preferably from 3 to 6. The shape of the nonmagnetic powder may be any of acicular, spherical, polyhedral, or plate-shaped. The nonmagnetic powder having a Mohs' hardness ranging from 4 to 10 is preferred. The stearic acid (SA) adsorption capacity of the nonmagnetic powder preferably ranges from 1 to 20 micromol/m², more preferably from 2 to 15 micromol/m², further preferably from 3 to 8 micromol/m². The pH of the nonmagnetic powder preferably ranges from 3 to 6. The surface of these nonmagnetic powders is preferably treated with Al₂O₃, SiO₂, TiO₂, ZrO₂, SnO₂, Sb₂O₃, ZnO and Y₂O₃. The surface-treating agents of preference with regard to dispersibility are Al₂O₃, SiO₂, TiO₂ and ZrO₂, and Al₂O₃, SiO₂ and ZrO₂ are further preferable. These may be used singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders are: Nanotite from Showa Denko K. K.; HIT-100 and ZA-G1 from Sumitomo Chemical Co., Ltd.; α-hematite DPN-250, DPN-250BX, DPN-245, DPN-270BX, DPN-500BX, DBN-SA1 and DBN-SA3 from Toda Kogyo Corp.; titanium oxide TTO-51B, TTO-55A, TTO-55B, TTO-55C, TTO-55S, TTO-55D, SN-100, α-hematite E270, E271, E300 and E303 from Ishihara Sangyo Co., Ltd.; titanium oxide STT-4D, STT-30D, STT-30, STT-65C, and α-hematite α-40 from Titan Kogyo K. K.; MT-100S, MT-100T, MT-150W, MT-500B, MT-600B, MT-100F, and MT-500HD from Tayca Corporation; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO₂P25 from Nippon Aerogil; 100A and 500A from Ube Industries, Ltd.; and sintered products of the same. Particular preferable nonmagnetic powders are titanium dioxide and α-iron oxide.

Based on the objective, an organic powder may be added to the nonmagnetic layer. Examples are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827, which are expressly incorporated herein by reference in their entirety, may be employed.

The thermoplastic resins, thermosetting resins, reactive resins, and mixtures of the same may that have been described as binder components suitable for use in the magnetic layer may be employed as the binder of the nonmagnetic layer. The content of binder in the nonmagnetic layer falls within a range of, for example, 5 to 50 weight percent, preferably a range of 10 to 30 weight percent, of the nonmagnetic powder. When employing vinyl chloride resin, the binder content is desirably 5 to 30 weight percent; when employing polyurethane resin, the binder content is desirably 2 to 20 weight percent; and when employing polyisocyanate, the binder content is desirably 2 to 20 weight percent. These are desirably combined for use. For example, when head corrosion occurs due to a low level of dechlorination, it is possible to employ polyurethane alone or just polyurethane and isocyanate. When employing polyurethane in the nonmagnetic layer, polyurethane with a glass transition temperature of −50 to 150° C., preferably 0 to 100° C., and more preferably, 30 to 90° C.; an elongation at break of 100 to 2,000 percent; a stress at break of 0.05 to 10 kg/mm² (about 0.49 to 98 MPa), and a yield point of 0.05 to 10 kg/mm² (about 0.49 to 98 MPa) is desirably employed.

The quantity of binder added to the nonmagnetic layer; the proportion of vinyl chloride resin, polyurethane resin, polyisocyanate, or some other resin in the binder; the molecular weight of the various resins; the quantity of polar groups; the above-described physical characteristics of the resin; and the like may be altered as necessary and known techniques may be applied. For example, to improve head touch, the quantity of binder in the nonmagnetic layer may be increased to impart flexibility.

The polyisocyanates described above as magnetic layer components are examples of polyisocyanates that can be employed in the nonmagnetic layer.

The thickness of the nonmagnetic layer is desirably 0.1 to 2.0 micrometers. When the nonmagnetic layer is excessively thick, the effects of the undercoating layer in the present invention of suitably absorbing the high pressure that is locally exerted by contact between the magnetic layer and the magnetic head, and depressing the abrasive and carbon black, may be lost. The thickness of the nonmagnetic layer is preferably 0.2 to 1.5 micrometers, more preferably 0.3 to 1.0 micrometer.

### (Carbon Black)

The magnetic recording medium of the present invention can comprise carbon black in the magnetic layer and/or nonmagnetic layer. Examples of types of carbon black that are suitable for use are: furnace black for rubber, thermal for rubber, black for coloring and acetylene black. A specific surface area of 5 to 500 m²/g, a DBP oil absorption capacity of 10 to 400 ml/100 g, and an average particle size of 5 to 300 nm, preferably 10 to 250 nm, more preferably 20 to 200 nm are respectively desirable. A pH of 2 to 10, a moisture content of 0.1 to 10 percent, and a tap density of 0.1 to 1 g/cc are respectively desirable. Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemi Corporation; CONDUCTEX SC, RAVEN 150, 50, 40, 15 and RAVEN MT-P from Columbia Carbon Co., Ltd.; and Ketjen Black EC from Lion Akzo Co., Ltd. The carbon black employed may be surface-treated with a dispersant or grafted with resin, or have a partially graphite-treated surface. The carbon black may be dispersed in advance into the binder prior to addition to the coating liquid.

These carbon blacks may be used singly or in combination. The quantity of carbon black preferably ranges from 0.1 to 30 weight percent relative to the ferromagnetic powder or nonmagnetic powder, when carbon black is employed. In the magnetic layer, carbon black can work to prevent static, reduce the coefficient of friction (impart smoothness), impart light-blocking properties, enhance film strength, and the like; the properties vary with the type of carbon black employed. Carbon black can be mixed into the nonmagnetic layer to achieve the known effect of reducing surface resistivity and optical transmittance, and achieving a desired micro-Vicker's hardness. A lubricant stockpiling effect can also be achieved by incorporating carbon black into the nonmagnetic layer. Accordingly, based on characteristics required for the magnetic layer and nonmagnetic layer, different types of carbon black can be employed in the magnetic layer and nonmagnetic layer in light of various characteristics such as types, quantities, particle size, oil absorption capacity, electrical conductivity, and pH. The carbon black is preferably optimized for each layer. For example, Carbon Black Handbook compiled by the Carbon Black Association, which is expressly incorporated herein by reference in its entirety, may be consulted for types of carbon black suitable for use in the magnetic layer and/or nonmagnetic layer.

### (Electrically Conductive Polymer Compound)

In the magnetic recording medium of the present invention, an electrically conductive polymer compound can be incorporated into at least one layer from among the undercoating layer, nonmagnetic layer, and magnetic layer, preferably into the magnetic layer and/or nonmagnetic layer. The electrically conductive polymer compound can improve the electrically conductivity of the layer into which it is incorporated, and thus function to reduce the surface resistivity of the magnetic layer.

A known electrically conductive polymer compound can be employed in the present invention. An electrically conductive polymer compound with a π-electron conjugated system is particularly desirable.

Examples are: thiophene, 3-methyl thiophene, 3-octyl thiophene, 3-dodecyl thiophene, other 3-alkyl thiophenes, 3-methoxythiophene, 3,4-dimethyl thiophene, other 3,4-dialkyl thiophenes, 3,4-ethylenedioxythiophene, terthiophene, 2,5-bipyrroyl thiophene, pyrrole, N-methyl pyrrole, N-ethyl pyrrole, N-n-propyl pyrrole, N-n-butyl pyrrole, N-phenyl pyrrole, 3-methyl pyrrole, 3-ethyl pyrrole, 3-n-propyl pyrrole, 3-n-butyl pyrrole, 3-n-octyl pyrrole, bipyrrole, terpyrrole, methyl 3-methyl-4-pyrrole carboxylate, butyl 3-methyl-4-pyrrole carboxylate, 2,5′-biphenyl terpyrrole, 2,5″-bithienyl bipyrrole, p,p′-bipyrroyl benzene, p-phenylene, phenylene vinylene, thienylene, isothianaphthene, trans-bithienyl ethylene, trans-bithienyl-1,4-butadiene, aniline, anilidine, N-methyl aniline, other N-alkyl anilines, p-phenylene diamine, m-phenylene diamine, furan, substituted furan, and polymer compounds obtained from derivatives of the above (including copolymers and mixtures of two or more of the above).

The use of a polymer comprising a structural unit in the form of one or more monomers selected from the group consisting of 3-octyl thiophene, 3-dodecyl thiophene, 3,4-ethylene dioxythiophene, 3-octyl pyrrole, methyl 3-methyl-4-pyrrole carboxylate, aniline, and N-substituted aniline is particularly desirable from the perspective of solubility in solvents and the like. Poly(3,4-ethylenedioxythiophene), poly(methyl 3-methyl-4-pyrrole carboxylate), polyaniline, and/or derivatives thereof are preferred as electrically conductive polymer compounds. Polyaniline and/or derivatives thereof are of greater preference.

The molecular weight of the electrically conductive polymer compound is not specifically limited. A weight average molecular weight (Mw) of 1,000 to 1,000,000 is desirable, and 2,000 to 800,000 is preferred.

To achieve high electrical conductivity, various dopants are desirably employed in combination with the electrically conductive polymer compound with a π-electron conjugated system that is suitable for use in the present invention. The type of dopant is not specifically limited. By way of example, dopants having one or more acidic groups with an acid dissociation constant pKa of equal to or lower than 4.0 (such as sulfonic acid groups, carboxyl groups, and phenol groups) are desirable; examples are alkyl benzene sulfonic acids, alkyl naphthalene sulfonic acids, alkylene dinaphthalene sulfonic acids, and sulfophthalic acids. Examples thereof are benzene sulfonic acid derivatives such as those described in Japanese Unexamined Patent Publication (KOKAI) No. 2003-141709, which is expressly incorporated herein by reference in its entirety.

The dopants can be suitably selected based on the type and structure of the electrically conductive polymer compound employed. In the case of polypyrrole or a polypyrrole derivative, examples of desirable dopants are: 2,3-dicyclo-5,6-dicyano-1,4-benzoquinone (DDQ), 7,7,8,8-tetracyanoquinodimethane (TCNQ), tetracyanoethylene (TCNE), chloranyl, tetrafluorotetracyanoquinodimethane (TF-TCNQ), and DAMN derivatives (tetracyanopyrazine, tetracyanotetraazanaphthalene, and the like). These may form charge-transfer complexes with polypyrroles and polypyrrole derivatives, exhibiting a high degree of electrical conductivity.

When the electrically conductive polymer compound employed is polyaniline, a polyaniline derivative, polythiophene, or a polythiophene derivative, examples of desirable dopants are: inorganic acids such as sulfuric acid, nitric acid, hydrochloric acid, perchloric acid, hydrofluoric acid, and phosphoric acid; organic acids such as oxalic acid, formic acid, acrylic acid, methacrylic acid, benzenesulfonic acid, p-toluenesulfonic acid, trifluoroacetic acid, p-dodecylbenzenesulfonic acid, n-dodecylbenzenesulfonic acid, picric acid, m-nitrobenzoic acid, dichloroacetic acid, alkylsulfonic acid, alkyl-substituted naphthalenesulfonic acid, (±)-camphor-10-sulfonic acid, and alkylphosphate; and polymeric acids such as polystyrenesulfonic acid, polyacrylic acid, polymethacrylic acid, polyvinylsulfonic acid, polyallylsulfonic acid, polyvinylsulfuric acid, and polyphosphoric acid. These dopants form salts known as emeraldine salts with polyaniline and aniline derivatives, exhibiting a high degree of electrical conductivity.

The quantity of dopant employed is not specifically limited, and will vary with the electrically conductive polymer compound selected and the type of dopant. The quantity is desirably 5 to 600 weight parts, preferably 10 to 300 weight parts, per 100 weight parts of electrically conductive polymer compound. Good electrical conductivity can be achieved by suitably adjusting the quantity of dopant.

The electrically conductive polymer compound can be incorporated into the layers by a variety of methods. For example, part or all of the binder in the undercoating layer, nonmagnetic layer, or magnetic layer can be replaced with an electrically conductive polymer compound for use. When part of the binder is replaced with an electrically conductive polymer compound, 20 to 80 weight percent is desirably replaced, 30 to 70 weight percent is preferably replaced, and 30 to 60 is more preferably replaced.

The preferred method of incorporating an electrically conductive polymer compound into the layers is incorporation in the form of a thin coating on the surface of the ferromagnetic particles or nonmagnetic particles that are added to the magnetic layer or nonmagnetic layer.

For example, it is desirable to adhere the electrically conductive polymer compound in advance to the surface of the ferromagnetic particles or nonmagnetic particles and then disperse them in binder resin as a means of introduction into the magnetic layer or nonmagnetic layer. Adhesion to the surface of the ferromagnetic particles or nonmagnetic particles in advance makes it possible to efficiently impart a high degree of electrical conductivity to the magnetic layer or nonmagnetic layer with a small quantity of electrically conductive polymer compound. As a result, the electrical conductivity of the layer can be improved and the surface resistivity of the magnetic layer can be lowered without causing deterioration of the surface properties of the nonmagnetic layer or magnetic layer, or diminishing the content of magnetic particles in the magnetic layer.

The layers to which the electrically conductive polymer compound is added and the quantities added can be suitably adjusted based on the targeted surface resistivity of the magnetic layer.

### (Abrasives)

Known materials chiefly having a Mohs' hardness of 6 or greater may be employed either singly or in combination as abrasives in the present invention. These include: α-alumina with an α-conversion rate of equal to or greater than 90 percent, β-alumina, silicon carbide, chromium oxide, cerium oxide, α-iron oxide, corundum, synthetic diamond, silicon nitride, silicon carbide, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers, more preferably 0.05 to 1.0 micrometer, and further preferably, 0.05 to 0.5 micrometer. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed in the present invention may be acicular, spherical, cubic, or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. Addition of abrasives to the magnetic layer can improve the cleaning effect for the magnetic head. Abrasives may be added as needed to the nonmagnetic layer. Addition of abrasives to the nonmagnetic layer can be done to control surface shape, control how the abrasive protrudes, and the like. The particle size and quantity of the abrasives added to the magnetic layer and nonmagnetic layer are preferably set to optimal values.

### (Backcoat Layer)

Generally, computer data recording-use magnetic recording medium (magnetic tapes) are required to have far better repeat running properties than audio and video tapes. In order to maintain such high running durability, a backcoat layer is preferably provided on the opposite surface of the nonmagnetic support from the surface on which the magnetic layer is provided. Carbon black and inorganic powders are desirably incorporated into the backcoat layer.

Examples of inorganic powders that can be added to the backcoat layer are inorganic powders having an average particle size of 80 to 250 nm and a Mohs' hardness of 5 to 9. Examples of inorganic powders that are suitable for use are: α-iron oxide, α-alumina, chromium oxide (Cr₂O₃), and TiO₂. Of these, α-iron oxide, α-alumina are employed with preference.

Any of the carbon blacks commonly employed in magnetic recording media may be widely employed in the backcoat layer. For example, furnace black for rubber, thermal for rubber, black for coloring and acetylene black may be employed. To ensure that irregularities in the backcoat do not transfer to the magnetic layer, the particle diameter of the carbon black is desirably equal to or smaller than 0.3 micrometer, with 0.01 to 0.1 micrometer being preferred. Carbon black is desirably employed in the backcoat layer in a quantity ensuring an optical transmittance (the transmittance level as measured by the TR-927 made by Macbeth Corp.) of equal to or less than 2.0.

The use of two types of carbon black having different mean particle sizes is advantageous to enhance running durability. In this case, a first carbon black having a mean particle size falling within a range of 0.01 to 0.04 micrometer and a second carbon black having a mean particle size falling within a range of 0.05 to 0.3 micrometer are desirably combined. The content of the second carbon black is suitably 0.1 to 10 weight parts, preferably 0.3 to 3 weight parts, per 100 weight parts of the sum of inorganic powders and the first carbon black. The quantity of binder employed can be desirably selected within a range of 40 to 150 weight parts, preferably 50 to 120 weight parts, more preferably 60 to 110 weight parts, per 100 weight parts of the total weight of inorganic powder and carbon black. Conventionally known thermoplastic resins, thermosetting resins, reactive resins, and the like may be employed as the binder used in the backcoat layer.

### (Additives)

Substances having lubricating effects, antistatic effects, dispersive effects, plasticizing effects, or the like may be employed as additives in the undercoating layer, magnetic layer, nonmagnetic layer and backcoat layer. Examples of additives are: molybdenum disulfide; tungsten disulfide; graphite; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; phenylphosphonic acid; α-naphthylphosphoric acid; phenylphosphoric acid; diphenylphosphoric acid; p-ethylbenzenephosphonic acid; phenylphosphinic acid; aminoquinones; various silane coupling agents and titanium coupling agents; fluorine-containing alkylsulfuric acid esters and their alkali metal salts; monobasic fatty acids (which may contain an unsaturated bond or be branched) having 10 to 24 carbon atoms and metal salts (such as Li, Na, K, and Cu) thereof; monohydric, dihydric, trihydric, tetrahydric, pentahydric or hexahydric alcohols with 12 to 22 carbon atoms (which may contain an unsaturated bond or be branched); alkoxy alcohols with 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty acid esters of monoalkyl ethers of alkylene oxide polymers; fatty acid amides with 8 to 22 carbon atoms; and aliphatic amines with 8 to 22 carbon atoms.

Specific examples of the additives in the form of fatty acids are: capric acid, caprylic acid, lauric acid, myristic acid, palmitic acid, stearic acid, behenic acid, oleic acid, elaidic acid, linolic acid, linolenic acid, and isostearic acid. Examples of esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentylglycol didecanoate, and ethylene glycol dioleyl. Examples of alcohols are oleyl alcohol, stearyl alcohol, and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K. K.), which is expressly incorporated herein by reference in its entirety. These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

The lubricants and surfactants suitable for use in the present invention each have different physical effects. The type, quantity, and combination ratio of lubricants producing synergistic effects can be optimally set for a given objective. It is conceivable to control bleeding onto the surface through the use of fatty acids having different melting points in the nonmagnetic layer and the magnetic layer; to control bleeding onto the surface through the use of esters having different boiling points, melting points, and polarity; to improve the stability of coatings by adjusting the quantity of surfactant; and to increase the lubricating effect by increasing the amount of lubricant in the intermediate layer. The present invention is not limited to these examples.

All or some of the additives used in the present invention may be added at any stage in the process of manufacturing the undercoating layer coating liquid, nonmagnetic layer coating liquid, magnetic layer coating liquid, and backcoat layer coating liquid. For example, they may be mixed with the ferromagnetic powder or nonmagnetic powder before a kneading step; added during a step of kneading the ferromagnetic powder or nonmagnetic powder, the binder, and the solvent; added during a dispersing step; added after dispersing; or added immediately before coating. Part or all of the additives may be applied by simultaneous or sequential coating after the magnetic layer or nonmagnetic layer has been applied to achieve a specific purpose. Depending on the objective, the lubricant may be coated on the surface of the magnetic layer after calendering or making slits. Known organic solvents may be employed in the present invention. For example, the solvents described in Japanese Unexamined Patent Publication (KOKAI) Showa No. 6-68453, which is expressly incorporated herein by reference in its entirety, may be employed.

### (Manufacture of Coating Liquid)

The undercoating layer coating liquid can be manufactured by adding a radiation-curable compound and additives as needed to a coating solvent and dissolving them therein.

The process for manufacturing coating liquids for magnetic and nonmagnetic layers comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, electrically conductive polymer compounds, abrasives, antistatic agents, lubricants, solvents, and the like, may be added at the beginning of, or during, any of the steps. Moreover, the individual starting materials may be divided up and added during two or more steps. For example, the binder may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. When a kneader is employed, the ferromagnetic powder or nonmagnetic powder and all or part of the binder (preferably equal to or higher than 30 weight percent of the entire quantity of binder) can be kneaded in a range of 15 to 500 parts per 100 parts of the ferromagnetic powder. Details of the kneading process are described in Japanese Unexamined Patent Publication (KOKAI) Heisei Nos. 1-106338 and 1-79274, which are expressly incorporated herein by reference in their entirety. Further, glass beads, a dispersing medium with a high specific gravity such as zirconia beads, titania beads and steel beads are preferably employed to disperse the coating liquids for magnetic and nonmagnetic layers. The particle diameter and fill ratio of these dispersing media are preferably optimized for use. A known dispersing device may be employed.

### (Method of Manufacturing Magnetic Recording Medium)

The magnetic recording medium of the present invention is desirably manufactured by the following method. An undercoating layer coating liquid containing a radiation-curable compound is coated on a nonmagnetic support. The undercoating layer coating liquid is then dried and the radiation-curable compound is cured to form an undercoating layer. A nonmagnetic layer coating liquid is then coated on the undercoating layer and the nonmagnetic layer coating liquid is dried to form a nonmagnetic layer. A magnetic layer coating liquid is then coated on the nonmagnetic layer and the magnetic layer coating liquid is dried to form a magnetic layer. In this manner, a magnetic recording medium can be obtained in which the nonmagnetic layer and magnetic layer are manufactured by the sequential multilayering method. It is possible to manufacture the magnetic recording medium by the simultaneous multilayering method by forming the nonmagnetic layer on the undercoating layer and coating the magnetic layer coating liquid on the nonmagnetic layer while the nonmagnetic layer is still wet. As set forth above, use of the sequential multilayering method is desirable in the present invention.

In this process, it is desirable to sequentially and continuously form the undercoating layer, nonmagnetic layer, and magnetic layer on a nonmagnetic support that is fed from a roll of nonmagnetic support stock material to obtain a magnetic recording medium web, wind the web to manufacture a roll of magnetic recording medium stock material, and cut the magnetic recording medium web of the roll of magnetic recording medium stock material into tape form to obtain a magnetic recording medium tape.

The backcoat layer can be formed in advance on the rear surface of the nonmagnetic support and the nonmagnetic support on which the backcoat layer has been formed can be fed from the roll of nonmagnetic support stock material. It is also possible to feed just the nonmagnetic support from the roll of nonmagnetic support stock material, and then coat the backcoat layer to the rear surface of the nonmagnetic support during the period where the undercoating layer, nonmagnetic layer, and magnetic layer are formed on the front surface of the nonmagnetic support and the magnetic recording medium is being wound into a roll of magnetic recording medium stock material.

A suitable method of manufacturing the magnetic recording medium of the present invention will be described below with reference to FIG. 5. However, the magnetic recording medium of the present invention is not limited to that manufactured by the method set forth below.

FIG. 5 shows a schematic of an example of a magnetic recording medium production line. In this example, backcoat layer 18 is formed in advance on the rear surface of nonmagnetic support 10, which is then wound to fabricate a roll of nonmagnetic support stock material 30.

Nonmagnetic support 10 on which backcoat layer 18 has been formed is sequentially fed from roll of nonmagnetic support stock material 30. Undercoating layer coating element 32 applies an undercoating layer coating liquid to it, after which it is fed to undercoating layer drying and curing element 34. Undercoating layer drying and curing element 34 dries the undercoating layer coating liquid that has been applied on nonmagnetic support 10 and cures the radiation-curable compound contained in the undercoating layer coating liquid by irradiation with radiation, thereby forming undercoating layer 12 on the surface of nonmagnetic support 10. Next, nonmagnetic layer coating element 36 applies a nonmagnetic layer coating liquid on undercoating layer 12 on nonmagnetic support 10 on which backcoat layer 18 and undercoating layer 12 have been formed, and feeds it to nonmagnetic layer drying element 38. Nonmagnetic layer drying element 38 dries the nonmagnetic layer coating liquid that has been applied to undercoating layer 12, forming nonmagnetic layer 14 on the surface side of nonmagnetic support 10. Next, magnetic layer coating element 40 applies a magnetic layer coating liquid on nonmagnetic layer 14 on the nonmagnetic support 10 on which backcoat layer 18, undercoating layer 12, and nonmagnetic layer 14 have been formed, and feeds it to magnetic layer drying element 42. Magnetic layer drying element 42 dries the magnetic layer coating liquid that has been applied to nonmagnetic layer 14, forming magnetic layer 16 on the surface side of nonmagnetic support 10. Nonmagnetic support 10 on the rear surface of which backcoat layer 18 has been formed and on the front surface of which undercoating layer 12, nonmagnetic layer 14, and magnetic layer 16 have been formed is wound up to obtain a roll of magnetic recording medium stock material 44.

The details of the process of manufacturing the magnetic recording medium will be described next.

### (Coating Method)

The undercoating layer, nonmagnetic layer, magnetic layer and backcoat layer may be formed by a known process, such as an extrusion coating method, roll coating method, gravure coating method, microgravure coating method, air knife coating method, die coating method, curtain coating method, dip coating method, or wire bar coating method. Particularly when coating the nonmagnetic layer and magnetic layer by the sequential multilayering method, it is desirable to employ the extrusion coating method to manufacture the magnetic layer.

When forming the magnetic layer by the sequential multilayering method, a coating method is desirably employed in which there are two slits, one for coating and one for recovery, an excess amount of coating liquid is discharged from the coating slit, and the excess amount of coating liquid following coating on a web is picked up by aspiration into the recovery slit. In this coating method, the pressure conditions for aspirating the excess coating liquid through the recovery slit are desirably optimized to produce a magnetic layer in the form of a thin film that is free of coating nonuniformity.

Specifically, the formation of the undercoating layer, nonmagnetic layer and magnetic layer can be carried out on a continuously running nonmagnetic support. The coating of the magnetic layer coating liquid is carried out by discharging the magnetic layer coating liquid that has been fed into a coating head from a coating slit of the coating head onto the nonmagnetic layer that has been formed on the nonmagnetic support in a quantity in excess of the quantity required to form a magnetic layer of desired thickness while the nonmagnetic layer and a lip surface of the font end of the coating head are in a state of close proximity, and the magnetic layer coating liquid that has been coated in excess is picked up by aspiration through a recovery slit provided downstream from the coating slit as viewed in the running direction of the nonmagnetic support, wherein the aspiration is carried out so as to satisfy equation (I) below when the liquid pressure at the aspiration inlet of the recovery slit is denoted as P (MPa):

0.05>P≧0 (I)

In the above coating method, when a pump aspirating the magnetic layer coating liquid that has been coated in excess is used for aspiration, the aspiration desirably satisfies equation (II) below when the pressure on the aspiration inlet side of the aspiration pump is denoted as PIN (MPa):

PIN≧−0.02 (II)

This coating method is described in detail in Japanese Unexamined Patent Publication (KOKAI) No. 2003-236452 or English language family member, US2003/0157251A1 and U.S. Pat. No. 6,759,091, which are expressly incorporated herein by reference in their entirety.

In the present invention, it is preferable that the formation of the undercoating layer, nonmagnetic layer and magnetic layer is carried out sequentially on the nonmagnetic support that is fed from a nonmagnetic support stock roll, and following the formation of the nonmagnetic layer and magnetic layer, winding the nonmagnetic support to obtain a magnetic recording medium stock roll, and cutting part of the magnetic recording medium stock roll to obtain a magnetic recording medium in the form of a tape. For example, it is difficult to inexpensively manufacture a large quantity of magnetic recording media by a method in which a nonmagnetic support that has been wound up into a roll is fed, an undercoating layer and nonmagnetic layer are formed, the nonmagnetic support is wound up, and the nonmagnetic support is fed out again to form the magnetic layer. By contrast, as set forth above, a large quantity of magnetic recording media can be inexpensively manufactured by feeding out a nonmagnetic support that has been wound into a roll, forming the undercoating layer, forming the nonmagnetic layer, and, once these layers have been formed, forming the magnetic layer without ever winding the nonmagnetic support. Layers other than the undercoating layer, nonmagnetic layer, and magnetic layer are also desirably formed between when the nonmagnetic support is fed and when it is wound. For example, when a backcoat layer is provided, the backcoat layer is desirably formed between when the nonmagnetic support is fed and when it is wound.

To enhance productivity, the conveyance rate of the nonmagnetic support during the formation of each layer is preferably equal to or higher than 100 m/min, more preferably equal to or higher than 200 m/min, further preferably equal to or higher than 300 m/min, and still more preferably, equal to or higher than 400 m/min. The faster the conveyance rate, the better the productivity achieved. However, an excessively high conveyance rate tends to cause coating problems (coating striae, coating nonuniformity). Thus, a coating rate of equal to or lower than 700 m/min is desirable.

To orient the ferromagnetic powder in the magnetic layer in a desired orientation state, orientation processing is normally conducted following coating of the magnetic layer coating liquid while the magnetic layer coating liquid is still wet.

The ferromagnetic metal powder is desirably oriented in the longitudinal direction with cobalt magnets and solenoids.

In the case of orientation of hexagonal ferrite powder, three-dimensional randomness in the in-plane directions and the vertical direction is generally readily achieved, but in-plane two-dimensional randomness is also possible. A known method such as magnets with opposite poles positioned opposite each other can also be employed to impart isotropic magnetic characteristics in a circumferential direction by effecting vertical orientation. When conducting particularly high-density recording, vertical orientation is desirable.

The coating liquids use to form the various layers can be dried by blowing warm air onto the coating liquid after it has been applied, for example. The temperature of the air used for drying is desirably equal to or higher than 60° C. The flow rate of the air used for drying can be set based on the amount of the coating and the temperature of the warm air. It is also possible to conduct suitable predrying prior to introduction into the magnetic zone for orientation processing following application of the magnetic layer coating liquid.

After coating and drying the coating liquids for forming individual layers as set forth above, the magnetic recording medium is normally calendered. The rolls used in calendering may be heat-resistant plastic rolls, such as rolls made of epoxy, polyimide, polyamide, or polyimidoamide, or metal rolls. In the calendering, the processing temperature is desirably 50° C. or above, preferably 90° C. or above. The linear pressure in calendering is desirably 200 kg/cm or greater (about 196 kN/m or greater), preferably 300 kg/cm or greater (about 294 kN/m or greater).

### EXAMPLES

The present invention will be described in detail below based on examples and comparative examples. However, the present invention is not limited to the examples. Further, the “parts” given in Examples are weight parts unless specifically stated otherwise.

### (Preparation of Lubricant A)

To a flask were charged 86 parts of 1-tetradecanol, 264 parts of hexane, and 35 parts of pyridine, and the mixture was cooled while being stirred. While continuing cooling and stirring, 42 parts of 2-ethylhexyl chloroformate were added dropwise to the flask over 2 hours. While continuing to stir the contents of the flask, it was exposed to room temperature for 6 hours. Water was added to the reaction solution, the mixture was stirred, the mixture was left standing, a separating funnel was employed to remove the aqueous layer, methanol was added, the mixture was stirred, the mixture was left standing, the methanol phase was separated, and this process was repeated three times. The residual hexane solution was concentrated under reduced pressure and a crude product of lubricant A was obtained in the form of 135 parts of a colorless transparent liquid.

This liquid was diluted two-fold with hexane and purified by column chromatography. The hexane solution was then concentrated under reduced pressure, yielding 77 parts of lubricant A.

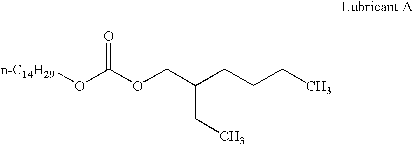

### (Preparation of Lubricant B)

With the exception that the l-tetradecanol was replaced with 1-hexadecanol, lubricant B was prepared by precisely the same method as lubricant A.

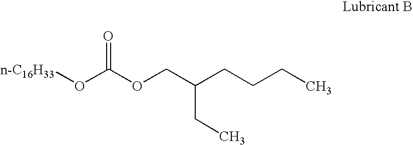

### (Preparation of Lubricant C)

With the exception that the 1-tetradecanol was replaced with 1-dodecanol, lubricant C was prepared by precisely the same method as lubricant A.

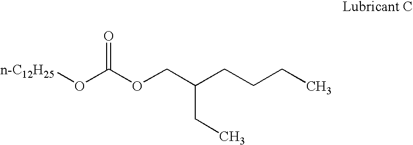

### (Preparation of Lubricant D)

With the exception that the 2-ethylhexyl chloroformate was replaced with 2-methylpropyl chloroformate, lubricant D was prepared by precisely the same method as lubricant A.

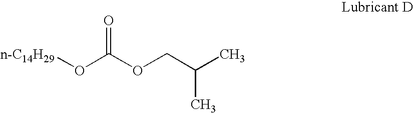

### (Preparation of Lubricant E)

With the exception that the 2-ethylhexyl chloroformate was replaced with 2-methylbutyl chloroformate, lubricant E was prepared by precisely the same method as lubricant A.

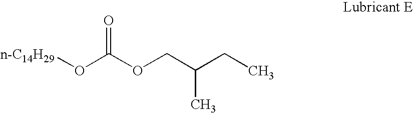

### (Preparation of Lubricant F)

With the exceptions that the l-tetradecanol was replaced with 1-dodecanol and the 2-ethylhexyl chloroformate was replaced with 2-methylpropyl chloroformate, lubricant F was prepared by precisely the same method as lubricant A.

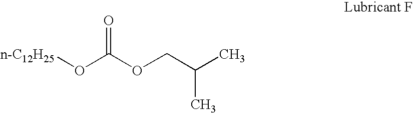

### (Preparation of Lubricant G)

With the exceptions that the l-tetradecanol was replaced with 1-dodecanol and the 2-ethylhexyl chloroformate was replaced with 2-methylbutyl chloroformate, lubricant G was prepared by precisely the same method as lubricant A.

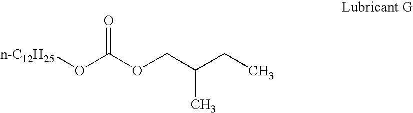

### (Preparation of Lubricant H)

With the exception that the 1-tetradecanol was replaced with 2-ethyltetradecanol, lubricant H was prepared by precisely the same method as lubricant A.

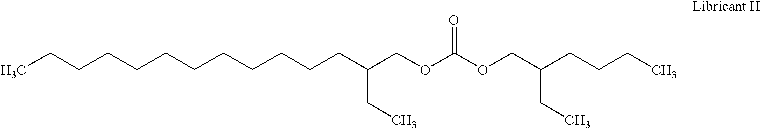

### (Preparation of Lubricant I)

With the exception that the l-tetradecanol was replaced with 1-octadecanol, lubricant I was prepared by precisely the same method as lubricant A.

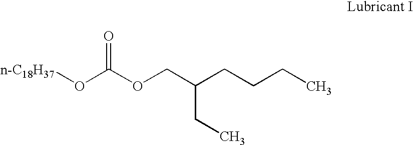

### (Preparation of Lubricant J)

With the exceptions that the 1-tetradecanol was replaced with 1-octadecanol and the 2-ethylhexyl chloroformate was replaced with methyl chloroformate, lubricant J was prepared by precisely the same method as lubricant A.

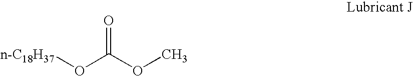

### (Preparation of Lubricant K)

With the exceptions that the 1-tetradecanol was replaced with 1-octadecanol and the 2-ethylhexyl chloroformate was replaced with butyl chloroformate, lubricant K was prepared by precisely the same method as lubricant A.

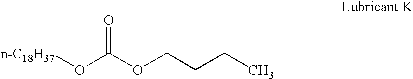

### (Preparation of Lubricant L)

With the exceptions that the 1-tetradecanol was replaced with 1-hexanol and the 2-ethylhexyl chloroformate was replaced with hexyl chloroformate, lubricant L was prepared by precisely the same method as lubricant A.

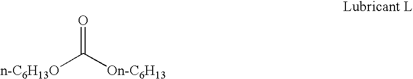

(Preparation of lubricant M)

With the exceptions that the 1-tetradecanol was replaced with 1-tetracosanol and the 2-ethylhexyl chloroformate was replaced with 1-tetracosyl chloroformate, lubricant M was prepared by precisely the same method as lubricant A.

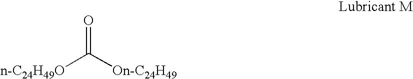

### (Preparation of Lubricant N)

With the exceptions that the 1-tetradecanol was replaced with 1-butanol and the 2-ethylhexyl chloroformate was replaced with 1-butyl chloroformate, lubricant N was prepared by precisely the same method as lubricant A.

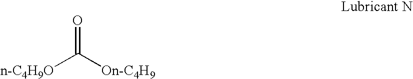

### (Preparation of Lubricant O)

With the exceptions that the 1-tetradecanol was replaced with 1-octacosanol and the 2-ethylhexyl chloroformate was replaced with 1-octacosyl chloroformate, lubricant O was prepared by precisely the same method as lubricant A.

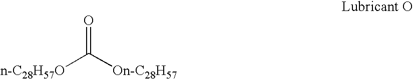

### (Preparation of Lubricant P)

Lubricant P below was prepared by the known method.

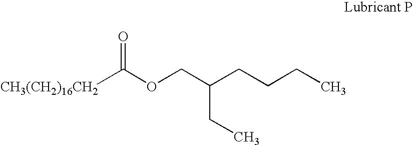

### (Preparation of Lubricant Q)

Lubricant Q below was prepared by the known method.

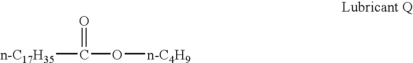

### (Nonmagnetic Support)

Commercial polyethylene-2,6-naphthalene dicarboxylate film (PEN, 5.0 micrometers in thickness) was employed as a nonmagnetic support.

### (Preparation of Undercoating Layer Coating Liquid 1)

To 20 parts of commercial urethane acrylate monomer (EBECRYL4858, made by Daicel-Cytec Company, Ltd.) were added 64 parts of methyl ethyl ketone and 16 parts of cyclohexanone, and the solution was stirred. The solution was then passed through a filter with a mean pore diameter of 0.04 micrometer to prepare undercoating layer coating liquid 1.

An undercoating layer prepared with undercoating layer coating liquid 1 exhibited a lower indentation hardness than the nonmagnetic support.

### (Preparation of Undercoating Layer Coating Liquid 2)

To 16 parts of commercial urethane acrylate monomer (EBECRYL4858, made by Daicel-Cytec Company, Ltd.) were added 4 parts of pentaerythritol triacrylate, 64 parts of methyl ethyl ketone, and 16 parts cyclohexanone, and the solution was stirred. The solution was then passed through a filter with a mean pore diameter of 0.04 micrometer to prepare undercoating layer coating liquid 2.

An undercoating layer prepared with undercoating layer coating liquid 2 exhibited a higher indentation hardness than the undercoating layer prepared with undercoating layer coating liquid 1, but a lower indentation hardness than the nonmagnetic support.

### (Preparation of Undercoating Layer Coating Liquid 3)

To 20 parts of a polyfunctional urethane acrylate oligomer with a coating film indentation hardness when cured by irradiation with radiation that was higher than that of the nonmagnetic support (a polyethylene-2,6-naphthalate film) were added 64 parts of methyl ethyl ketone and 16 parts of cyclohexanone, and the solution was stirred.

The solution was then passed through a filter with a mean pore diameter of 0.04 micrometer to prepare undercoating layer coating liquid 3.

An undercoating layer prepared with undercoating layer coating liquid 3 exhibited a higher indentation hardness than the nonmagnetic support.

### (Preparation of Nonmagnetic Layer Coating Liquids a to q)

The nonmagnetic metal particles indicated below, carbon black, a, polyvinyl chloride resin, polyurethane resin, methyl ethyl ketone, and cyclohexanone were kneaded and dispersed in a known open kneader.

The kneaded product prepared was dispersed in a known Dyno-mill (using zirconia beads 0.5 mm in diameter) to prepare dispersion solutions of nonmagnetic particles.

| | |
|---|---|
| Nonmagnetic particle αFe₂O₃ (acicular) | 80 parts |
| Specific surface area by BET method: 52 m²/g | |
| Surface treatment agent: Al₂O₃, SiO₂ | |
| Mean major axis length: 100 nm | |
| pH: 9.0 | |
| Tap density: 0.8 g/cc | |
| DBP oil absorption capacity: 27-38 g/100 g | |
| Carbon black | 20 parts |
| Mean primary particle diameter: 0.016 micrometer | |
| DBP oil absorption capacity: 120 mL/100 g | |
| pH: 8.0 | |
| Specific surface area by BET method: 250 m²/g | |
| Volatile content: 1.5 percent | |
| Phosphoric acid dispersing agent | 3 parts |
| Polyvinyl chloride resin (MR110 made by Nippon | 12 parts |
| Zeon Co., Ltd.) | |
| Polyurethane resin (based on branched side | 7.5 parts |
| chain-containing polyester polyol/diphenylmethane | |
| diisocyanate, containing 70 eq./ton of polar group in the form | |
| of —SO₃Na group) | |
| Methyl ethyl ketone | 150 parts |
| Cyclohexanone | 150 parts |

To the above-prepared dispersion solutions were admixed polyisocyanate, the lubricant listed in Table 1, stearic acid, methyl ethyl ketone, and cyclohexanone, indicated below, and the mixtures were stirred. The mixtures were dispersed in a known ultrasonic disperser. The mixtures were then passed through filters with a mean pore diameter of 1.0 micrometer to prepare nonmagnetic layer coating liquids a to q.

| | |
|---|---|
| Polyisocyanate (Coronate L made by Nippon | 5 parts |
| Polyurethane Industry Co., Ltd.) | |
| Lubricant listed in Table 1 | 2 parts |
| Stearic acid | 1 part |
| Methyl ethyl ketone | 5 parts |
| Cyclohexanone | 75 parts |

### (Preparation of Nonmagnetic Layer Coating Liquid r)

To a titanium autoclave were charged 100 parts of the αFe2O₃ nonmagnetic metal particles (acicular) indicated below, 900 parts of ion-exchange water, and a suitable quantity of HCl to adjust the pH to 4.3. Five parts of pyrrole were dissolved in 50 parts of ethanol and added to the above solution. The mixture was reacted in a nitrogen atmosphere for 5 hours at 100° C. Following the reaction, the reaction solution was cooled, filtered, and dried at 60° C. In this manner, αFe2O₃ (acicular) coated with 4.0 weight percent of polypyrrole relative to the αFe₂O₃ (acicular) was prepared.

Nonmagnetic particle αFe₂O₃ (acicular)

Specific surface area by BET method: 52 m²/g

Surface treatment agent: Al₂O₃, SiO₂

Mean major axis length: 100 nm

pH: 9.0

Tap density: 0.8 g/cc

DBP oil absorption capacity: 27-38 g/100 g

With the exception that the above-prepared αFe2O₃ (acicular) coated with polypyrrole and the lubricant indicated in Table 1 were employed, nonmagnetic layer coating liquid r was prepared in precisely the same manner as nonmagnetic layer coating liquids a to q.

### (Preparation of Nonmagnetic Layer Coating Liquid s)

To a titanium autoclave were charged 100 parts of the αFe₂O₃ nonmagnetic metal particles (acicular) employed in nonmagnetic layer coating liquid r and an 8 weight percent solution of dedoped polyaniline dissolved in N-methylpyrrolidone. The mixture was then stirred for 20 minutes in a disper under a nitrogen atmosphere. The dispersion was filtered, redoped with 1N dilute sulfuric acid solution, filtered, and dried. In this manner, αFe₂O₃ (acicular) coated with 5.0 weight percent of polyaniline relative to the αFe₂O₃ (acicular) was prepared.

With the exception that the above-prepared αFe2O₃ (acicular) coated with polyaniline and the lubricant indicated in Table 1 were employed, nonmagnetic layer coating liquid s was prepared in precisely the same manner as nonmagnetic layer coating liquids a to q.

### (Preparation of Magnetic Layer Coating Liquids A to Q)

Ferromagnetic metal particles indicated below, a phosphoric acid dispersing agent, 5 parts of polyurethane resin PU1 (weight average molecular weight (Mw): 170,000), 5 parts of polyurethane resin PU2 (weight average molecular weight (Mw): 80,000) of the same molecular structure as polyurethane resin PU1, and 10 parts of polyvinyl chloride resin (MR110 made by Nippon Zeon Co., Ltd.) were kneaded and dispersed in a known open kneader with methyl ethyl ketone and cyclohexanone. To the kneaded product prepared was added α-alumina and carbon black, indicated below. The mixtures were dispersed in a known Dyno-mill (using zirconia beads 0.5 mm in diameter) to prepare dispersion solutions of ferromagnetic metal particles.

| | |
|---|---|
| Ferromagnetic metal particle (acicular) | 100 parts |
| Composition Fe/Co = 100/25 | |
| Coercivity Hc: 215 kA/m (about 2700 Oe) | |
| Specific surface area by BET method: 70 m²/g | |
| Surface treatment agent: Al₂O₃, SiO₂, Y₂O₃ | |
| Mean major axis length: 45 nm | |
| Mean acicular ratio: 4 | |
| Saturation magnetization σs: 110 A · m²/kg | |
| (about 110 emu/g) | |
| Phosphoric acid dispersing agent | 2 parts |
| Polyurethane resin PU1 (weight average molecular | 5 parts |
| weight (Mw): 170,000) | |
| Polar group (—SO₃Na) content: 70 eq./ton | |
| Polyurethane resin PU2 (weight average molecular | 5 parts |
| weight (Mw): 80,000) | |
| Polar group (—SO₃Na) content: 70 eq./ton | |
| Polyvinyl chloride resin (MR110 made by Nippon | 10 parts |
| Zeon Co., Ltd.) | |
| α-alumina (Mohs' hardness: 9, mean particle | 5 parts |
| diameter: 0.1 micrometer) | |
| Carbon black (mean particle diameter: 0.08 micrometer) | 0.3 part |
| Methyl ethyl ketone | 150 parts |
| Cyclohexanone | 150 parts |

To the above-prepared dispersion solutions were admixed polyisocyanate, the lubricant listed in Table 1, stearic acid, methyl ethyl ketone, and cyclohexanone, indicated below and the mixtures were stirred. The mixtures were dispersed in a known ultrasonic disperser. The mixtures were then passed through filters with a mean pore diameter of 1.0 micrometer to prepare magnetic layer coating liquids A to Q.

| | |
|---|---|
| Polyisocyanate (Coronate L made by Nippon | 4 parts |
| Polyurethane Industry Co., Ltd.) | |
| Lubricant listed in Table 1 | 1.5 parts |
| Stearic acid | 0.5 part |
| Methyl ethyl ketone | 250 parts |
| Cyclohexanone | 120 parts |

### (Preparation of a Backcoat Layer Coating Liquid)

The starting materials and solvents indicated below were kneaded by a known method and then dispersed in a known Dyno-mill (with zirconia beads 0.5 mm in diameter).

| | |
|---|---|
| Carbon black A (mean particle diameter: 0.04 micrometer) | 100 parts |
| Carbon black B (mean particle diameter: 0.1 micrometer) | 4 parts |
| α-alumina (mean particle diameter: 0.2 micrometer) | 1 parts |
| Nitrocellulose (Sernova BTH 1/2 made by | 55 parts |
| Asahi Kasei Corporation) | |
| Polyurethane resin | 45 parts |
| Copper phthalocyanine dispersing agent | 5 parts |
| Copper oleate | 5 parts |
| Precipitated barium sulfate | 5 parts |
| Methyl ethyl ketone | 700 parts |
| Toluene | 700 parts |

The starting materials listed below were admixed with the dispersion solution that had been prepared and the mixture was stirred. The mixture was passed through a filter having a mean pore diameter of 1.0 micrometer to prepare a backcoat layer coating liquid.

| | |
|---|---|
| Polyester resin (Vylon 300 made by Toyobo Co,, Ltd.) | 5 parts |
| Polyisocyanate (Coronate L made by Nippon | 15 parts |
| Polyurethane Industry Co., Ltd.) | |

### Preparation of Magnetic Recording Medium—1

### Example 1-1

Undercoating layer coating liquid 1 was coated and dried by a known method on the surface of a nonmagnetic support that had been corona discharge treated by a known method. While replacing the excess oxygen with nitrogen (nitrogen purging), a 4.5 Mrad electron beam was irradiated in an atmosphere with an oxygen concentration of less than 100 ppm to cure the radiation-curable compound and prepare an undercoating layer 0.3 micrometer in thickness.

Nonmagnetic layer coating liquid a prepared as set forth above was coated and dried on the above-prepared undercoating layer by a known method in a manner yielding a dry film thickness of 0.7 micrometer to prepare a nonmagnetic layer.

Magnetic layer coating liquid A prepared as set forth above was coated and dried on the above-prepared nonmagnetic layer by the method described in Japanese Unexamined Patent Publication (KOKAI) No. 2003-236452 in a manner yielding a dry film thickness of 0.06 micrometer.

Following (0.7 seconds after) coating of magnetic layer coating liquid A, while the magnetic layer was still wet, orientation processing was conducted with cobalt magnets having a magnetic force of 0.5 T (5,000 G) and with solenoids having a magnetic force of 0.4 T (4,000 G), after which the magnetic layer coating liquid was dried to prepare a magnetic layer.

On the opposite side (rear surface side) of the nonmagnetic support from the magnetic layer, the backcoat layer coating liquid prepared as set forth above was coated and dried by a known method in a manner yielding a dry thickness of 0.6 micrometer to prepare a backcoat layer.

The four layers of the undercoating layer, nonmagnetic layer, magnetic layer, and backcoat layer were sequentially applied during the period between when the nonmagnetic support was fed and when it was wound up. The conveyance rate of the nonmagnetic support was 350 m/minute.

The nonmagnetic support on which the undercoating layer, nonmagnetic layer, magnetic layer, and backcoat layer had been formed was subjected to a surface smoothing treatment at a processing rate of 150 m/minute with a seven-stage calender (linear pressure 3,000 kg/cm) comprised of metal rolls (temperature: 100° C.). The magnetic recording medium that had been subjected to surface smoothing was then heat treated for 48 hours at 70° C. and slit to a ½ inch width to prepare a magnetic recording medium in tape form.

### Example 1-2

With the exceptions that nonmagnetic layer coating liquid b and magnetic layer coating liquid B were employed, a magnetic recording medium in tape form was prepared in precisely the same manner as in Example 1-1.

### Example 1-3

With the exceptions that nonmagnetic layer coating liquid c and magnetic layer coating liquid C were employed, a magnetic recording medium in tape form was prepared in precisely the same manner as in Example 1-1.

### Example 1-4

With the exceptions that nonmagnetic layer coating liquid d and magnetic layer coating liquid D were employed, a magnetic recording medium in tape form was prepared in precisely the same manner as in Example 1-1.

### Example 1-5

With the exceptions that nonmagnetic layer coating liquid e and magnetic layer coating liquid E were employed, a magnetic recording medium in tape form was prepared in precisely the same manner as in Example 1-1.

### Example 1-6

With the exceptions that nonmagnetic layer coating liquid f and magnetic layer coating liquid F were employed, a magnetic recording medium in tape form was prepared in precisely the same manner as in Example 1-1.

### Example 1-7

With the exceptions that nonmagnetic layer coating liquid g and magnetic layer coating liquid G were employed, a magnetic recording medium in tape form was prepared in precisely the same manner as in Example 1-1.

### Example 1-8

With the exceptions that nonmagnetic layer coating liquid h and magnetic layer coating liquid H were employed, a magnetic recording medium in tape form was prepared in precisely the same manner as in Example 1-1.

### Example 1-9

With the exceptions that nonmagnetic layer coating liquid i and magnetic layer coating liquid I were employed, a magnetic recording medium in tape form was prepared in precisely the same manner as in Example 1-1.

### Example 1-10

With the exceptions that nonmagnetic layer coating liquid j and magnetic layer coating liquid J were employed, a magnetic recording medium in tape form was prepared in precisely the same manner as in Example 1-1.

### Example 1-11

With the exceptions that nonmagnetic layer coating liquid k and magnetic layer coating liquid K were employed, a magnetic recording medium in tape form was prepared in precisely the same manner as in Example 1-1.

### Example 1-12

With the exceptions that nonmagnetic layer coating liquid l and magnetic layer coating liquid L were employed, a magnetic recording medium in tape form was prepared in precisely the same manner as in Example 1-1.

### Example 1-13

With the exceptions that nonmagnetic layer coating liquid m and magnetic layer coating liquid M were employed, a magnetic recording medium in tape form was prepared in precisely the same manner as in Example 1-1.

### Comparative Example 1-A

With the exceptions that nonmagnetic layer coating liquid n and magnetic layer coating liquid N were employed, a magnetic recording medium in tape form was prepared in precisely the same manner as in Example 1-1.

### Comparative Example 1-B

With the exceptions that nonmagnetic layer coating liquid o and magnetic layer coating liquid O were employed, a magnetic recording medium in tape form was prepared in precisely the same manner as in Example 1-1.

### Comparative Example 1-C

With the exceptions that nonmagnetic layer coating liquid p and magnetic layer coating liquid P were employed, a magnetic recording medium in tape form was prepared in precisely the same manner as in Example 1-1.

### Comparative Example 1-D

With the exceptions that nonmagnetic layer coating liquid q and magnetic layer coating liquid Q were employed, a magnetic recording medium in tape form was prepared in precisely the same manner as in Example 1-1.

### Comparative Example 1-E

With the exception that no undercoating layer was provided in Example 1-11, a magnetic recording medium was prepared in precisely the same manner as in Example 1-11.

### Example 1-14

With the exception that the nonmagnetic layer in Example 1-9 was prepared so that the thickness of the nonmagnetic layer was 1.0 micrometer, a magnetic recording medium in tape form was prepared in precisely the same manner as in Example 1-9.

### Example 1-15

With the exception that the nonmagnetic layer in Example 1-9 was prepared so that the thickness of the nonmagnetic layer was 1.4 micrometer, a magnetic recording medium in tape form was prepared in precisely the same manner as in Example 1-9.

### Example 1-16

With the exception that undercoating layer liquid 2 was employed in Example 1-9, a magnetic recording medium in tape form was prepared in precisely the same manner as in Example 1-9.

### Comparative Example 1-F

With the exception that undercoating layer liquid 3 was employed in Example 1-9, a magnetic recording medium in tape form was prepared in precisely the same manner as in Example 1-9.

### Example 1-17

With the exception that nonmagnetic layer coating liquid r was employed in Example 1-16, a magnetic recording medium in tape form was prepared in precisely the same manner as in Example 1-16.

### Example 1-18

With the exception that nonmagnetic coating liquid s was employed in Example 1-16, a magnetic recording medium in tape form was prepared in precisely the same manner as in Example 1-16.

The lubricants employed in the above coating liquids and whether or not an electrically conductive polymer was present in the coating liquid are indicated in Table 1.

TABLE 1
Lubricants and electrically conductive polymer compounds employed
in the coating liquids

| | | | | | | | | Electrically |
|---|---|---|---|---|---|---|---|---|
| | | | | | | | | conductive |
| | | | | | | | Melting | polymer |
| | | | | | | | point | compound in |
| | | | Molecular structure of lubricant | | | | of | the |
| | Lubricant | | R¹ | | R² | | lubricant | nonmagnetic |
| Coating liquid | No. | Type of lubricant | Structure | Name | Structure | Name | (° C.) | layer |
| Nonmagnetic layer: a | A | Carbonic ester | Branched | 2-ethylhexyl | Linear | Tetradecyl | −23° C. | None |
| Magnetic layer: A | | | chain | | chain | | | |
| Nonmagnetic layer: b | B | Carbonic ester | Branched | 2-ethylhexyl | Linear | Hexadecyl | −3° C. | None |
| Magnetic layer: B | | | chain | | chain | | | |
| Nonmagnetic layer: c | C | Carbonic ester | Branched | 2-ethylhexyl | Linear | Dodecyl | ≦0° C. | None |
| Magnetic layer: C | | | chain | | chain | | | |
| Nonmagnetic layer: d | D | Carbonic ester | Branched | 2- | Linear | Tetradecyl | ≦0° C. | None |
| Magnetic layer: D | | | chain | methylpropyl | chain | | | |
| Nonmagnetic layer: e | E | Carbonic ester | Branched | 2-methylbutyl | Linear | Tetradecyl | ≦0° C. | None |
| Magnetic layer: E | | | chain | | chain | | | |
| Nonmagnetic layer: f | F | Carbonic ester | Branched | 2- | Linear | Dodecyl | ≦0° C. | None |
| Magnetic layer: F | | | chain | methylpropyl | chain | | | |
| Nonmagnetic layer: g | G | Carbonic ester | Branched | 2-methylbutyl | Linear | Dodecyl | ≦0° C. | None |
| Magnetic layer: G | | | chain | | chain | | | |
| Nonmagnetic layer: h | H | Carbonic ester | Branched | 2-ethylhexyl | Branched | 2- | ≦0° C. | None |
| Magnetic layer: H | | | chain | | chain | ethyltetradecyl | | |
| Nonmagnetic layer: i | I | Carbonic ester | Branched | 2-ethylhexyl | Linear | Octadecyl | 13° C. | None |
| Magnetic layer: I | | | chain | | chain | | | |
| Nonmagnetic layer: j | J | Carbonic ester | Linear | Methyl | Linear | Octadecyl | 46° C. | None |
| Magnetic layer: J | | | chain | | chain | | | |
| Nonmagnetic layer: k | K | Carbonic ester | Linear | Butyl | Linear | Octadecyl | 53° C. | None |
| Magnetic layer: K | | | chain | | chain | | | |
| Nonmagnetic layer: l | L | Carbonic ester | Linear | Hexyl | Linear | Hexyl | — | None |
| Magnetic layer: L | | | chain | | chain | | | |
| Nonmagnetic layer: m | M | Carbonic ester | Linear | Tetracosyl | Linear | Tetracosyl | — | None |
| Magnetic layer: M | | | chain | | chain | | | |
| Nonmagnetic layer: n | N | Carbonic ester | Linear | Butyl | Linear | Butyl | — | None |
| Magnetic layer: N | | | chain | | chain | | | |
| Nonmagnetic layer: o | O | Carbonic ester | Linear | Octacosyl | Linear | Octacosyl | — | None |
| Magnetic layer: O | | | chain | | chain | | | |
| Nonmagnetic layer: p | P | Fatty acid ester | — | — | — | — | 30° C. | None |
| Magnetic layer: P | | | | | | | | |
| Nonmagnetic layer: q | Q | Fatty acid ester | — | — | — | — | 23° C. | None |
| Magnetic layer: Q | | | | | | | | |
| Nonmagnetic layer: r | I | Carbonic ester | Branched | 2-ethylhexyl | Linear | Octadecyl | 13° C. | Polypyrrol |
| | | | chain | | chain | | | |
| Nonmagnetic layer s | I | Carbonic ester | Branched | 2-ethylhexyl | Linear | Octadecyl | 13° C. | Polyaniline |
| | | | chain | | chain | | | |

### (Evaluation of Magnetic Recording Media)

The magnetic recording media prepared in Examples 1-1 to 1-18 and Comparative Examples 1-A to 1-F were evaluated with regard to the following items.

(1) Evaluation of Indentation Hardness (DH)

A nanoindentation hardness tester (model No.: ENT-1100a, made by Elionix Co., Ltd.) was employed. A triangular pyramidal indenter (65° edge angle, 115° adjacent edge angle, made of diamond) was employed. The indentation load was continuously increased to 6 mgf (58.8 μN) over 10 seconds, maintained at 6 mgf for 1 second, and then removed over 10 seconds. The indentation hardness (DH) was calculated as set forth above.

The indentation hardness (DH) of the undercoating layer and that of the nonmagnetic support were measured under conditions of temperatures of 5° C. and 40° C. (both at 50 percent relative humidity).

The indentation hardness of the nonmagnetic supports employed in Examples and Comparative Examples was 50.0 kg/mm² (about 0.49 GPa) under conditions of a temperature of 5° C. at 50 percent relative humidity and 42.3 kg/mm² (about 0.41 GPa) under conditions of a temperature of 40° C. at 50 percent relative humidity. A comparison of the indentation hardness of the support to that of the undercoating layer over a humidity range of 10 to 80 percent relative humidity at a temperature of 5° C. and over a humidity range of 10 to 80 percent relative humidity at a temperature of 40° C. revealed relations of magnitudes that were identical to those at 50 percent relative humidity.

(2) Evaluation of the Surface Resistivity of the Magnetic Layer

As shown in FIG. 4, the tape was positioned on electrodes (made of 24 carat gold) and the surface of the magnetic layer of the magnetic recording medium in tape form was brought into contact with the electrodes. A force of 1.62 N was applied to each edge of the tape, a d.c. voltage of 100 V was applied between the electrodes, and the current was measured to calculate the surface resistivity.

(3) Evaluation of Error Generation

The magnetic recording media that had been prepared were stored for one month under conditions of 40° C. and 80 percent relative humidity. An LTO-Gen3 drive (made by IBM) was then employed to repeatedly conduct an operation of reproduction and winding under environmental conditions of 40° C. and 80 percent relative humidity. Error generation (failed running and errors in reading a recorded signal) were evaluated on the following five-step scale.

Error generation was similarly evaluated on the following five-step scale for environmental conditions of 5° C. and 10 percent relative humidity, 5° C. and 80 percent relative humidity, and 40° C. and 5 percent relative humidity. It was desirable for as large number of operations as possible to be repeated without the generation of errors.

1: No error generation with 300 repetitions

2: Error generation at 200 or more but fewer than 300 repetitions

3: Error generation at 100 or more but fewer than 200 repetitions

4: Error generation at 50 or more but fewer than 100 repetitions

5: Error generation at fewer than 50 repetitions

(4) Evaluation of Magnetic Head Grime

The magnetic recording media that had been prepared were stored for one month under conditions of 40° C. and 80 percent relative humidity. An LTO-Gen3 drive (made by IBM) was then employed to repeatedly conduct 300 cycles of an operation of feeding and rewinding under environmental conditions of 40° C. and 80 percent relative humidity. The degree of grime adhering to the magnetic head was evaluated on the following four-step scale.

The degree of magnetic head grime adhesion was similarly evaluated on the following four-step scale for environmental conditions of 5° C. and 10 percent relative humidity, 5° C. and 80 percent relative humidity, and 40° C. and 5 percent relative humidity. It was desirable for as little grime as possible to adhere to the magnetic head.

1: Almost no grime present

2: Trace amount of grime present

3: Some grime present

4: A large amount of grime present

The results of the above are given in Tables 2 and 3.

TABLE 2
Results of performance evaluation

| | | | | | Indentation hardness | | |
|---|---|---|---|---|---|---|---|
| | | | | Nonmagnetic | of undercoating | | |
| | Coating liquid for eachlayer | | | layer | layer (kg/mm²) | | |
| | Undercoating | Nonmagnetic | | thickness | 5° C., | 40° C., | Surface resistivity |
| | layer | layer | Magnetic layer | (μm) | 50% RH | 50% RH | (Ω/□) |
| Ex. 1-1 | 1 | a | A | 0.7 | 34.2 | 30.1 | 9.5 × 10⁶ |
| Ex. 1-2 | 1 | b | B | 0.7 | 34.2 | 30.1 | 9.2 × 10⁶ |
| Ex. 1-3 | 1 | c | C | 0.7 | 34.2 | 30.1 | 9.1 × 10⁶ |
| Ex. 1-4 | 1 | d | D | 0.7 | 34.2 | 30.1 | 9.3 × 10⁶ |
| Ex. 1-5 | 1 | e | E | 0.7 | 34.2 | 30.1 | 9.4 × 10⁶ |
| Ex. 1-6 | 1 | f | F | 0.7 | 34.2 | 30.1 | 9.3 × 10⁶ |
| Ex. 1-7 | 1 | g | G | 0.7 | 34.2 | 30.1 | 9.2 × 10⁶ |
| Ex. 1-8 | 1 | h | H | 0.7 | 34.2 | 30.1 | 9.3 × 10⁶ |
| Ex. 1-9 | 1 | i | I | 0.7 | 34.2 | 30.1 | 9.4 × 10⁶ |
| Ex. 1-10 | 1 | j | J | 0.7 | 34.2 | 30.1 | 9.2 × 10⁶ |
| Ex. 1-11 | 1 | k | K | 0.7 | 34.2 | 30.1 | 9.2 × 10⁶ |
| Ex. 1-12 | 1 | l | L | 0.7 | 34.2 | 30.1 | 9.1 × 10⁶ |
| Ex. 1-13 | 1 | m | M | 0.7 | 34.2 | 30.1 | 9.2 × 10⁶ |
| Comp. Ex. 1-A | 1 | n | N | 0.7 | 34.2 | 30.1 | 9.3 × 10⁶ |
| Comp. Ex. 1-B | 1 | o | O | 0.7 | 34.2 | 30.1 | 9.2 × 10⁶ |
| Comp. Ex. 1-C | 1 | p | P | 0.7 | 34.2 | 30.1 | 9.4 × 10⁶ |
| Comp. Ex. 1-D | 1 | q | Q | 0.7 | 34.2 | 30.1 | 9.3 × 10⁶ |
| Comp. Ex. 1-E | None | k | K | 0.7 | — | — | 9.1 × 10⁶ |
| Ex. 1-14 | 1 | i | I | 1.0 | 34.2 | 30.1 | 7.3 × 10⁶ |
| Ex. 1-15 | 1 | i | I | 1.4 | 34.2 | 30.1 | 5.5 × 10⁶ |
| Ex. 1-16 | 2 | i | I | 0.7 | 41.5 | 35.6 | 9.5 × 10⁶ |
| Comp. Ex. 1-F | 3 | i | I | 0.7 | 54.0 | 47.2 | 9.4 × 10⁶ |
| Ex. 1-17 | 2 | r | I | 0.7 | 34.2 | 30.1 | 3.5 × 10⁶ |
| Ex. 1-18 | 2 | s | I | 0.7 | 34.2 | 30.1 | 9.5 × 10⁵ |

Note)
34.2 kg/mm² ≈ 0.34 GPa,
30.1 kg/mm² ≈ 0.30 GPa,
41.5 kg/mm² ≈ 0.41 GPa,
54.0 kg/mm² ≈ 0.53 GPa,
35.6 kg/mm² ≈ 0.35 GPa,
47.2 kg/mm² ≈ 0.46 GPa

TABLE 3
Results of performance evaluation

| | Error generation | | | | Head grime | | | |
|---|---|---|---|---|---|---|---|---|
| | 5° C., | 5° C., | 40° C., | 40° C., | 5° C., | 5° C., | 40° C., | 40° C., |
| | 10% RH | 80% RH | 10% RH | 80% RH | 10% RH | 80% RH | 10% RH | 80% RH |
| Ex. 1-1 | 1 | 1 | 1 | 1 | 1 | 1 | 1 | 1 |
| Ex. 1-2 | 1 | 1 | 1 | 1 | 1 | 1 | 1 | 1 |
| Ex. 1-3 | 2 | 1 | 1 | 1 | 2 | 1 | 1 | 1 |
| Ex. 1-4 | 2 | 1 | 1 | 2 | 2 | 1 | 1 | 2 |
| Ex. 1-5 | 2 | 1 | 1 | 1 | 2 | 1 | 1 | 1 |
| Ex. 1-6 | 2 | 1 | 1 | 2 | 2 | 1 | 1 | 2 |
| Ex. 1-7 | 2 | 1 | 1 | 2 | 2 | 1 | 1 | 2 |
| Ex. 1-8 | 2 | 1 | 1 | 2 | 2 | 1 | 1 | 2 |
| Ex. 1-9 | 2 | 1 | 1 | 2 | 2 | 1 | 1 | 2 |
| Ex. 1-10 | 3 | 2 | 1 | 2 | 3 | 2 | 1 | 2 |
| Ex. 1-11 | 3 | 2 | 1 | 2 | 3 | 2 | 1 | 2 |
| Ex. 1-12 | 3 | 3 | 2 | 3 | 3 | 3 | 2 | 3 |
| Ex. 1-13 | 3 | 3 | 2 | 3 | 3 | 3 | 2 | 3 |
| Comp. Ex. 1-A | 5 | 4 | 3 | 5 | 4 | 4 | 3 | 4 |
| Comp. Ex. 1-B | 5 | 4 | 3 | 5 | 4 | 4 | 3 | 4 |
| Comp. Ex. 1-C | 2 | 1 | 1 | 5 | 2 | 1 | 1 | 4 |
| Comp. Ex. 1-D | 2 | 1 | 1 | 5 | 2 | 1 | 1 | 4 |
| Comp. Ex. 1-E | 4 | 2 | 2 | 2 | 4 | 2 | 2 | 2 |
| Ex. 1-14 | 3 | 1 | 1 | 2 | 3 | 1 | 1 | 2 |
| Ex. 1-15 | 3 | 2 | 1 | 2 | 3 | 2 | 1 | 2 |
| Ex. 1-16 | 3 | 2 | 1 | 2 | 3 | 2 | 1 | 2 |
| Comp. Ex. 1-F | 4 | 2 | 2 | 2 | 4 | 2 | 2 | 2 |
| Ex. 1-17 | 2 | 2 | 1 | 2 | 2 | 2 | 1 | 2 |
| Ex. 1-18 | 2 | 2 | 1 | 2 | 2 | 2 | 1 | 2 |

### (Evaluation Results)

Magnetic recording media having extremely smooth magnetic layer surfaces of approximately identical center line average surface roughness (Ra) as measured by an atomic force microscope (AFM) were obtained in Examples 1-1 to 1-18, Comparative Examples 1-A to 1-D, and Comparative Example 1-F.

By contrast, in Comparative Example 1-E, in which no undercoating layer was employed, the center line average surface roughness (Ra) of the magnetic layer surface was high and the surface of the magnetic layer was somewhat rough. Accordingly, Comparative Example 1-E exhibited poorer electromagnetic characteristics (a lower S/N ratio) than the others.

The magnetic recording media of Examples 1-1 to 1-18 tended not to generate errors under various environmental conditions (5° C. and 10 percent relative humidity, 5° C. and 80 percent relative humidity, 40° C. and 10 percent relative humidity, 40° C. and 80 percent relative humidity). This was because the magnetic recording media of Examples 1-1 to 1-18 exhibited little adhesion of grime to the magnetic head under the various environmental conditions, and did not exhibit running failure due to increased friction.

Examples 1-10 and 1-11 exhibited a somewhat greater tendency to generate errors under environmental conditions of 5° C. and 10 percent relative humidity and 5° C. and 80 percent relative humidity than Examples 1-1 to 1-9. This was because the melting points of the carbonic esters employed in Examples 1-10 and 1-11 were somewhat high, resulting in a certain amount of deterioration in the lubricating property under the above environmental conditions, and a somewhat large amount of head grime.

Examples 1-12 and 1-13 exhibited somewhat greater error generation under all environmental conditions than Examples 1-1 to 1-9. This was because the total number of carbon atoms in R¹ and R² of the carbonic esters employed in Examples 1-1 to 1-9 was optimal and thus good lubricating property was achieved, resulting in lower head grime than in Example 1-12 and 1-13.

In Comparative Examples 1-A and 1-B, in which carbonic esters other than those denoted by general formula (1) were employed, there was a considerable tendency to generate errors under environmental conditions of 5° C. and 10 percent relative humidity, 5° C. and 80 percent relative humidity, and 40° C. and 80 percent relative humidity. This was because under these environmental conditions, considerable grime adhered to the magnetic head and running failure occurred due to poor lubricating property. This was attributed to the total number of carbon atoms in R¹ and R² being excessively low in Comparative Example 1-A and being excessively high in Comparative Example 1-B.

In Comparative Examples 1-C and 1-D, errors were generated quite readily under environmental conditions of 40° C. and 80 percent relative humidity. This was because under this environmental condition, considerable grime adhered to the magnet head, and running failure occurred due to the resulting increase in friction. The main component of the magnetic head grime in Comparative Examples 1-C and 1-D was fatty acid metal salts produced by the hydrolysis of fatty esters. This was attributed to greater tendency of decomposition of the fatty esters employed.

In Comparative Example 1-E, in which no undercoating layer was present, there was a greater tendency to generate errors under low humidity environmental conditions (5° C. and 10 percent relative humidity, 40° C. and 10 percent relative humidity) than in Example 1-11. The reason for the tendency to generate errors in Comparative Example 1-E was the large amount of magnetic head grime under these environmental conditions. This indicated that providing an undercoating layer having a lower indentation hardness than the nonmagnetic support effectively reduced magnetic head grime.

A comparison of Example 1-9 with Examples 1-14 and 1-15 revealed a certain tendency to produce errors as the thickness of the nonmagnetic layer increased. This was because magnetic head grime was somewhat greater. As the thickness of the nonmagnetic layer increased, the effect of the undercoating layer on reducing magnetic head grime decreased. Accordingly, it was desirable to suitably design the thickness of the nonmagnetic layer.

Comparative Example 1-F, which had an undercoating layer with a higher indentation hardness than the nonmagnetic support, exhibited a much higher tendency to generate errors under environmental conditions of 5° C. and 10 percent relative humidity, and 40° C. and 10 percent relative humidity, than Example 1-9. This was due to the considerable magnetic head grime under these environmental conditions, indicating that providing an undercoating layer with a lower indentation hardness than the nonmagnetic support had the effect of reducing magnetic head grime.

A comparison of Example 1-9 and Example 1-16 revealed that in Example 1-16, in which the indentation hardness of the undercoating layer was somewhat high, there was a certain tendency to generate errors. This was because of the large amount of magnetic head grime, and showed that as the hardness of the undercoating layer increased, the effect of the undercoating layer on reducing magnetic head grime diminished. Accordingly, it was desirable to suitably design the hardness of the undercoating layer.

Examples 1-17 and 1-18 exhibited less tendency to generate errors under environmental conditions of 5° C. and 10 percent relative humidity than Example 1-16. This was due to a reduction in magnetic head grime. Due to the low surface resistivity of the magnetic layer in Examples 1-17 and 1-18, the magnetic tape tended not to develop a charge, which was thought to prevent the adhesion of dust and the like. This was considered to be the reason for the tendency not to generate errors under these atmospheric conditions, since magnetic tapes have a particular tendency to develop charges under low-temperature, low-humidity environmental conditions in which there is little moisture in the atmosphere.

### Preparation of Magnetic Recording Medium—2

With the exception that the nonmagnetic layer and magnetic layer were coated by the simultaneous multilayering coating method, magnetic recording media were prepared in precisely the same manner as in Examples 1-1 to 1-18 and Comparative Examples 1-A to 1-F.

### (Evaluation of Magnetic Recording Media)

The magnetic recording media that were prepared were evaluated in the same manner as Examples 1-1 to 1-18 and Comparative Examples 1-A to 1-F.

### (Evaluation Results)

Results identical to those in Examples 1-1 to 1-18 and Comparative Examples 1-A to 1-F were obtained. Accordingly, the present invention was determined to be applicable to magnetic recording media in which the nonmagnetic layer and magnetic layer are prepared by the simultaneously multilayering coating method.

However, a comparison of the magnetic recording media that were prepared by the simultaneous multilayering coating method to the magnetic recording media of Examples 1-1 to 1-18 that were prepared by the sequential multilayering coating method revealed a somewhat greater tendency to generate errors in the former. This was attributed to partial intermixing of the magnetic layer and nonmagnetic layer.

Further, the magnetic recording media prepared by the simultaneous multilayering coating method exhibited more surface defects and a lower yield than the magnetic recording media prepared by the sequential multilayering coating method.

### Preparation of Magnetic Recording Medium—3

With the exception that the ferromagnetic metal particles (acicular) incorporated in the magnetic layer were replaced with the plate-shaped ferromagnetic hexagonal ferrite particles set forth below, magnetic recording media were prepared in precisely the same manner as in Examples 1-1 to 1-18 and Comparative Examples 1-A to 1-F.

Ferromagnetic hexagonal ferrite particle (plate-shaped)

Composition (molar ratio): Ba/Fe/Co/Zn=10/90/2/8

Coercivity Hc: 191 kA/m

Specific surface area by BET method: 50 m²/g

Plate diameter: 30 nm

Plate ratio: 3

Saturation magnetization: 60 A·m²/kg

### (Evaluation of Magnetic Recording Media)

The magnetic recording media that were prepared were evaluated in the same manner as Examples 1-1 to 1-18 and Comparative Examples 1-A to 1-F.

### (Evaluation Results)

Results identical to those in Examples 1-1 to 1-18 and Comparative Examples 1-A to 1-F were obtained. Accordingly, the present invention was determined to be applicable even when the ferromagnetic powder in the magnetic layer was replaced with ferromagnetic hexagonal ferrite particles.

Since the magnetic recording medium of the present invention can withstand use and storage under a variety of environments, it is suitable as a backup tape of which good reliability is required over long periods.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A magnetic recording medium comprising an undercoating layer comprising a radiation-curable compound that has been cured by irradiation with radiation, a nonmagnetic layer comprising a nonmagnetic powder and a binder, and a magnetic layer comprising a ferromagnetic powder and a binder in this order on a nonmagnetic support, wherein
the magnetic layer and/or the nonmagnetic layer comprise a carbonic ester denoted by general formula (1), and
the undercoating layer has an indentation hardness lower than that of the nonmagnetic support. 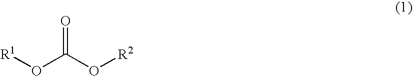
In general formula (1), each of R¹ and R² independently denotes a saturated hydrocarbon group, with a total number of carbon atoms in R¹ and R² being equal to or higher than 12 but equal to or lower than 50.

2. The magnetic recording medium according to claim 1, wherein, in general formula (1), at least one of R¹ and R² denotes a saturated hydrocarbon group having a branched structure.

3. The magnetic recording medium according to claim 2, wherein the branched structure is present at a β position in the saturated hydrocarbon group.

4. The magnetic recording medium according to claim 2, wherein, in general formula (1), one of R¹ and R² denotes 2-methylpropyl group, 2-methylbutyl group or 2-ethylhexyl group.

5. The magnetic recording medium according to claim 2, wherein, among R¹ and R² in general formula (1), one denotes a saturated hydrocarbon group having a branched structure and the other denotes a saturated hydrocarbon group having a linear structure.

6. The magnetic recording medium according to claim 5, wherein the saturated hydrocarbon group having a linear structure has 12 to 20 carbon atoms.

7. The magnetic recording medium according to claim 1, wherein the nonmagnetic layer has a thickness ranging from 0.1 to 2.0 μm.

8. The magnetic recording medium according to claim 1, wherein the magnetic layer has a surface resistivity ranging from 1×10⁴ to 1×10⁸ Ω/□.

9. The magnetic recording medium according to claim 1, which comprises an electrically conductive polymer compound in at least one of the undercoating layer, the nonmagnetic layer, and the magnetic layer.

10. The magnetic recording medium according to claim 9, wherein the electrically conductive polymer compound is polyaniline and/or a derivative thereof.
